(19) United States
(12) Patent Application Publication
(10) Pub. No.: US 2019/0163730 A1
(43) Pub. Date: May 30, 2019

(54) SYSTEMS AND METHODS FOR A MOBILE DEVICE APPLICATION HAVING A MARKUP-LANGUAGE DOCUMENT

(71) Applicant: Adam Reed, Torrance, CA (US)

(72) Inventor: Adam Reed, Torrance, CA (US)

(21) Appl. No.: 15/827,603

(22) Filed: Nov. 30, 2017

(51) Int. Cl. G06F 17/22; G06F 9/44; G06F 3/0488

(52) U.S. Cl. CPC G06F 17/2247; G06F 3/0488; G06F 8/315; G06F 8/33

(57) ABSTRACT

Systems and methods for generating an application for a mobile device. A markup-language document that includes a visible first element and a hidden second element is generated. The first element specifies first content, and a mapping of a first callback to a first event standard attribute. The second element specifies second content, and a first standard attribute having a first attribute value. First program instructions are generated for the first callback. The first program instructions include instructions for controlling a presentation engine of a mobile device to hide the first element and display the second element during rendering of the markup-language document by the presentation engine by using a DOM for the markup language. Application data is generated that includes the markup-language document and the first program instructions. The application data is provided to an application store system via a network.

### TECHNICAL FIELD

This disclosure relates generally to mobile device applications, and more specifically to new and useful systems and methods for a mobile device application having a markup-language document.

### BACKGROUND

A document object model (DOM) is an application programming interface (API) that treats an HTML, XML, or XHTML document as a tree structure. Each node of the tree structure is an object that represents a part of the document. The objects of the document tree structure can be manipulated programmatically, and any visible changes occurring as a result may be reflected in the display of the document. In some mobile devices, it may be impossible, difficult, or inconvenient to programmatically manipulate certain attributes of an HTML document by using a DOM. For example, on an Apple® iPad®, the webkitEnterFullscreen( ) method can be invoked only in response to a user action, such as clicking a button, and this method cannot be invoked in response to a load event, for example.

### BRIEF DESCRIPTION OF THE FIGURES

FIG. 1 is a schematic representation of a system, according to embodiments;

FIG. 2 is a schematic representation of application data, according to embodiments;

FIGS. 3A-3N are representations of exemplary application data, according to embodiments;

FIG. 4 is a representation of a method, according to embodiments;

FIG. 5 is a representation of a method, according to embodiments;

FIG. 6 is a representation of a method, according to embodiments;

FIGS. 7A-7B are representations of exemplary application data, according to embodiments;

FIGS. 8A-8F are representations of exemplary renderings of a markup-language document, according to embodiments;

FIG. 9 is a diagram depicting system architecture of an application developer system, according to embodiments;

FIG. 10 is a diagram depicting system architecture of an application store system, according to embodiments; and

FIG. 11 is a diagram depicting system architecture of a mobile device, according to embodiments.

### DESCRIPTION OF EMBODIMENTS

The following description of embodiments is not intended to limit the disclosure to these embodiments, but rather to enable any person skilled in the art to make and use the embodiments disclosed herein.

### Overview

In some mobile devices, it may be impossible, difficult, or inconvenient to programmatically manipulate certain attributes of an HTML document by using a DOM. For example, on an Apple® iPad®, the webkitEnterFullscreen( ) method can be invoked only in response to a user action, such as clicking a button, and this method cannot be invoked in response to a load event, for example. For example, on the iPad platform, an application cannot ordinarily use an HTML DOM to load and play a video in full-size in response to a single user-input received by the application. For some types of applications, it may be useful to load and play a video in full-size in response to a single user input. For example, in the context of a video tour guide application, the ability of a user to control loading and playing of a full-sized tour guide video clip in response to a single user action may improve usability of the video tour guide application. For example, in the context of an application that includes video advertisement, the ability of a user to control loading and playing of a full-sized advertisement video clip in response to a single user action may result in more user views of video advertisements. Other use cases are contemplated in which it may be useful to programmatically manipulate certain attributes of an HTML document by using a DOM, but such programmatic manipulation is impossible, difficult, or inconvenient.

Systems and methods for addressing the foregoing are provided herein.

In some embodiments, an application developer system generates a markup-language document (e.g., HTML, XML, etc.) that includes a visible first element and a hidden second element. The first element specifies: first content, a mapping of a first callback to a first event standard attribute. The second element specifies: second content, and a first standard attribute having a first attribute value. The application developer system generates first program instructions for the first callback. The first program instructions include instructions for controlling a presentation engine of a mobile device to hide the first element and display the second element during rendering of the markup-language document by the presentation engine by using a document object model (DOM) for the markup language. The application developer system generates application data that includes the markup-language document and the first program instructions. The application developer system provides the application data to an application store system via a network. The first element and the second element are standard elements of the DOM, and the first standard attribute is a standard attribute of the DOM.

### Systems

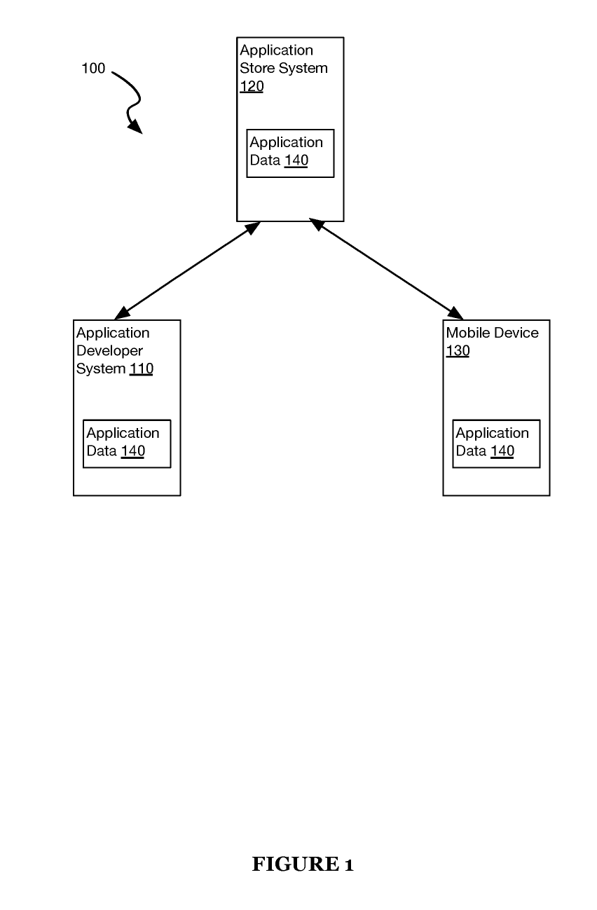

FIG. 1 is a schematic representation of a system 100, according to embodiments. In some embodiments, the system 100 includes an application developer system 110, an application store system 120, and at least one mobile device 130. In some embodiments, the application developer system 110 is communicatively coupled to the application store system 120 via the Internet. In some embodiments, the application store system 120 is communicatively coupled to mobile device 130 via the Internet.

In some embodiments, the application store system 120 is an Apple® application store. In some embodiments, the application store system 120 is Google® application store.

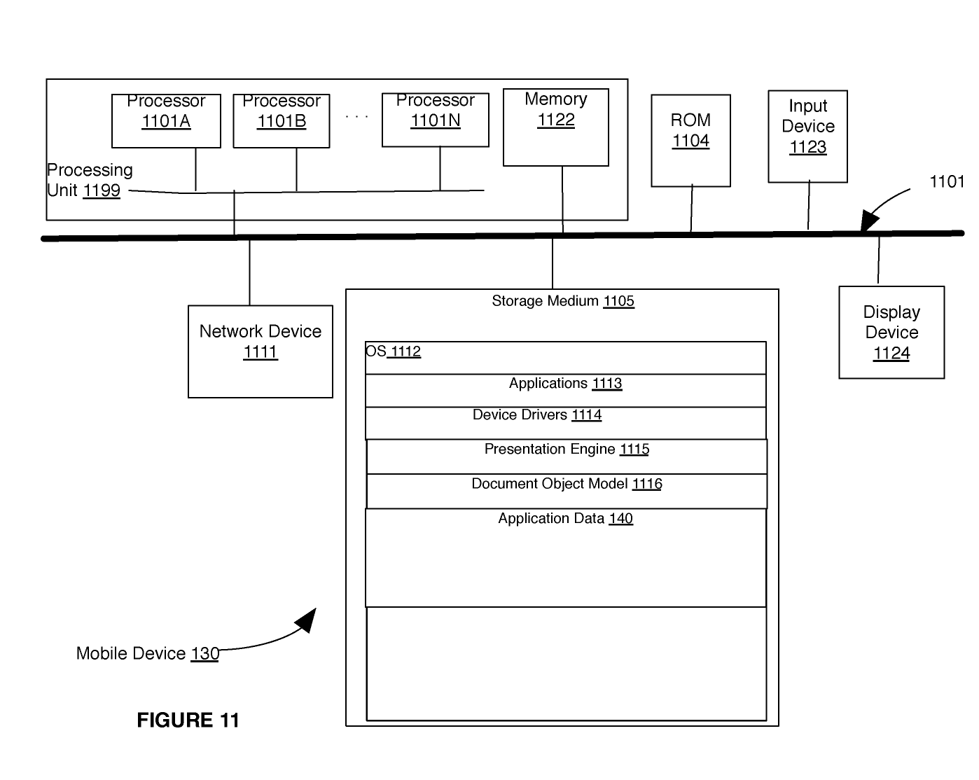

In some embodiments, the mobile device 130 includes a document object model (DOM) (e.g., 1116 of FIG. 11). In some embodiments, the DOM is an HTML DOM. In some embodiments, the DOM is an XML DOM. In some embodiments, the DOM is an HTML 5 DOM.

In some embodiments, the DOM includes standard elements and standard attributes. In some embodiments, the DOM includes standard elements and standard attributes as well as custom elements and custom attributes. In some embodiments, the DOM includes standard elements and standard attributes, and at least one custom element. In some embodiments, the DOM includes standard elements and standard attributes, and at least one custom attribute. In some embodiments, the DOM includes standard elements and standard attributes, and the standard elements and the standard attributes are elements attributes that are required by the DOM standard for the DOM. In some embodiments, the DOM standard for the DOM is the HTML DOM standard. In some embodiments, the DOM standard for the DOM is the HTML 5 DOM standard. In some embodiments, the DOM standard for the DOM is the XML DOM standard. In some embodiments, custom elements include custom elements for accessibility features. In some embodiments, custom attributes include custom attributes for accessibility features. In some embodiments, custom elements include custom elements for content personalization features. In some embodiments, custom attributes include custom attributes for content personalization features. In some embodiments, custom elements include custom elements for application configuration (e.g., configuration of the application of the data 140). In some embodiments, custom attributes include custom attributes for application configuration (e.g., configuration of the application of the data 140).

In some embodiments, the mobile device 130 includes a presentation engine (e.g., 1115 of FIG. 11). In some embodiments, the presentation engine is constructed to process the markup-language document in accordance with the DOM. In some embodiments, the presentation engine includes the DOM (e.g., the DOM 1116 of FIG. 11). In some embodiments, the presentation engine is constructed to execute program instructions for callbacks. In some embodiments, the presentation engine includes a scripting engine constructed to execute program instructions for callbacks. In some embodiments, the scripting engine is a JavaScript scripting engine. In some embodiments, the presentation engine is constructed to render the markup-language documents in accordance with style definitions included in the markup-language document. In some embodiments, the presentation engine includes a rendering engine that is constructed to render the markup-language documents in accordance with style definitions included in the markup-language document.

In some embodiments, the application developer system 110 includes the application data 140. In some embodiments, the application store system 120 includes the application data 140. In some embodiments, the mobile device 130 includes the application data 140.

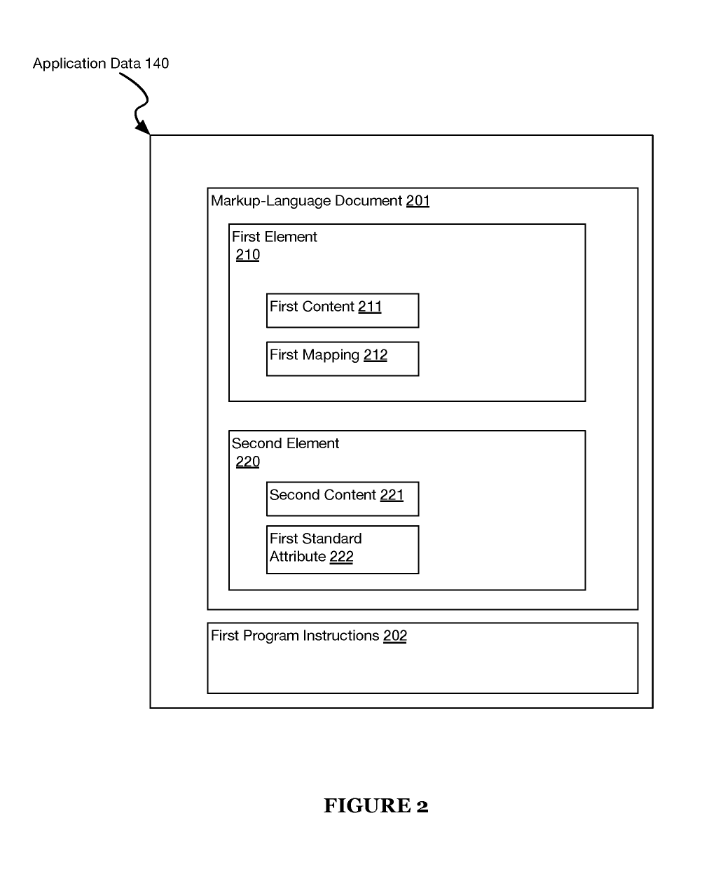

FIG. 2 depicts application data 140 in accordance with some embodiments. As shown in FIG. 2, the application data 140 includes a markup-language document 201 and program instructions 202. The program instructions 202 are program instructions that are executable by the presentation engine of the mobile device 130. In some embodiments, the markup-language document 201 includes a first element 210 and a second element 220.

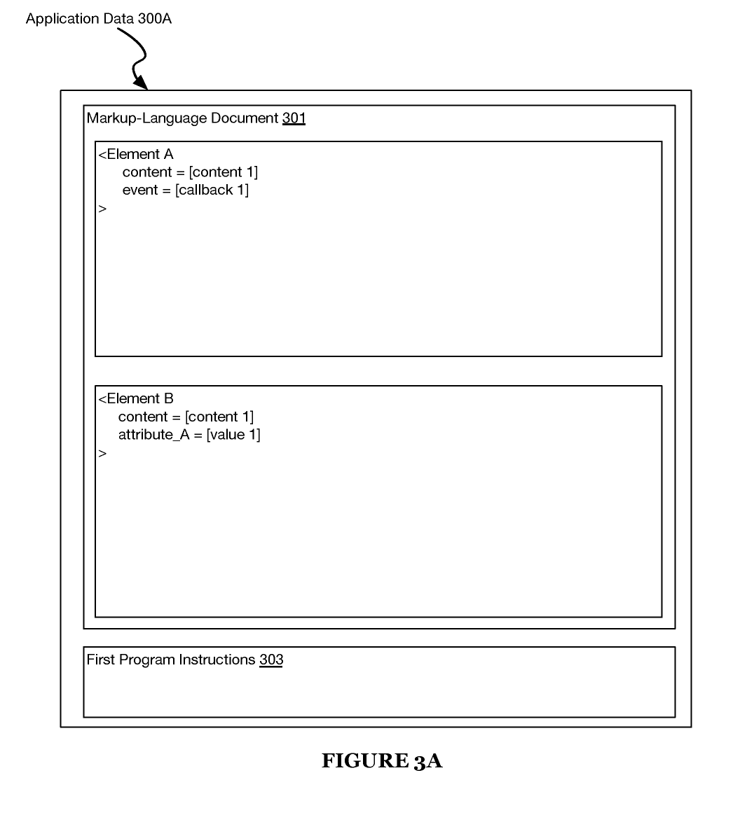

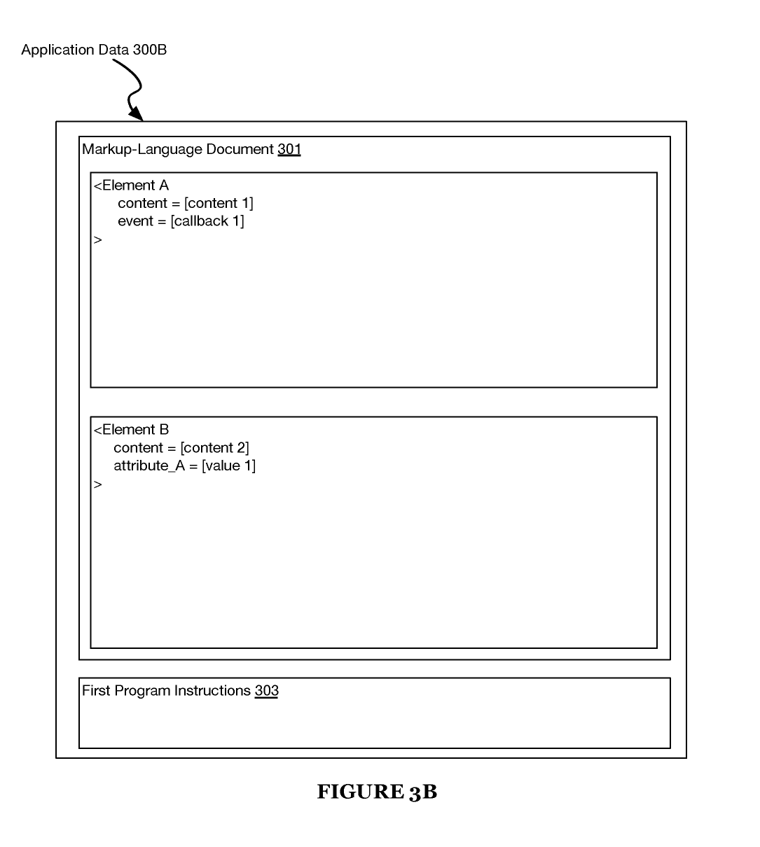

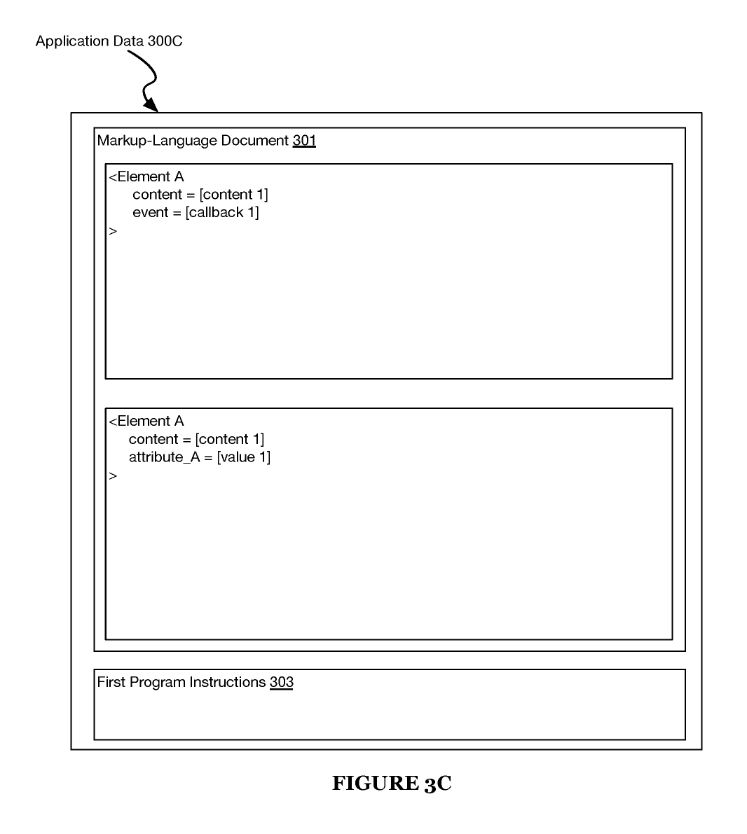

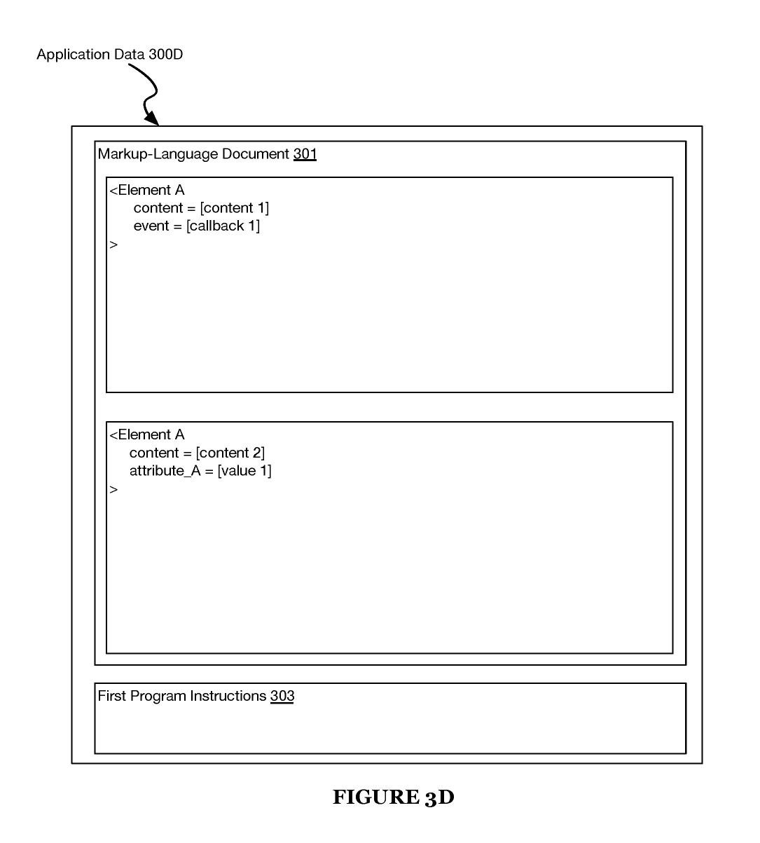

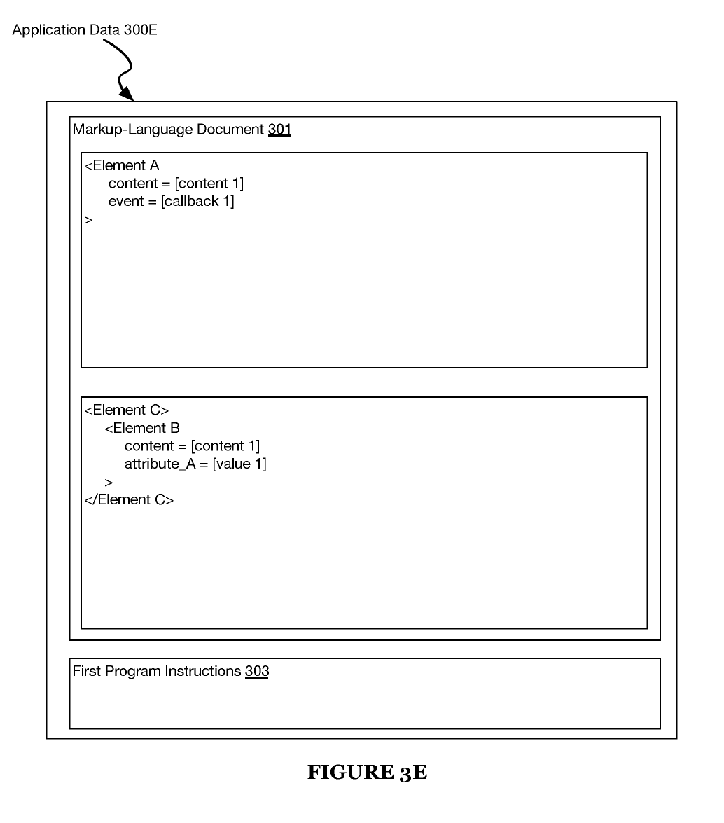

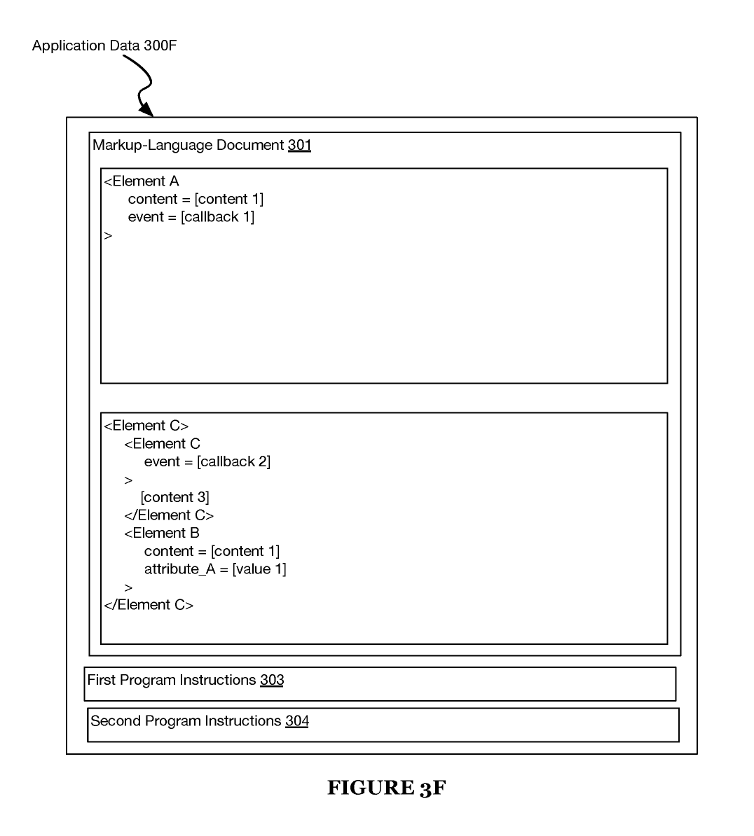

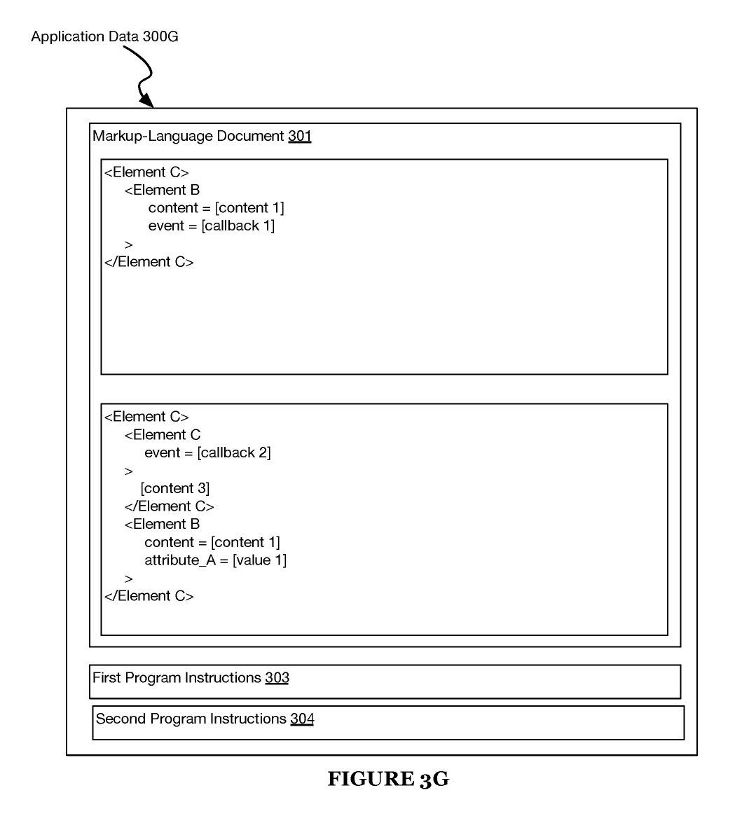

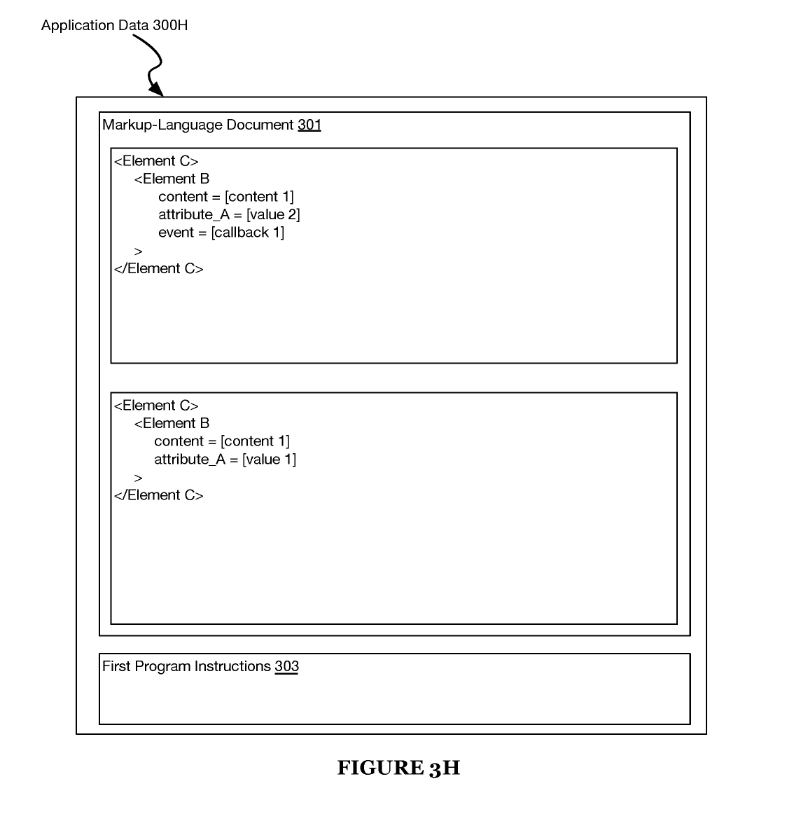

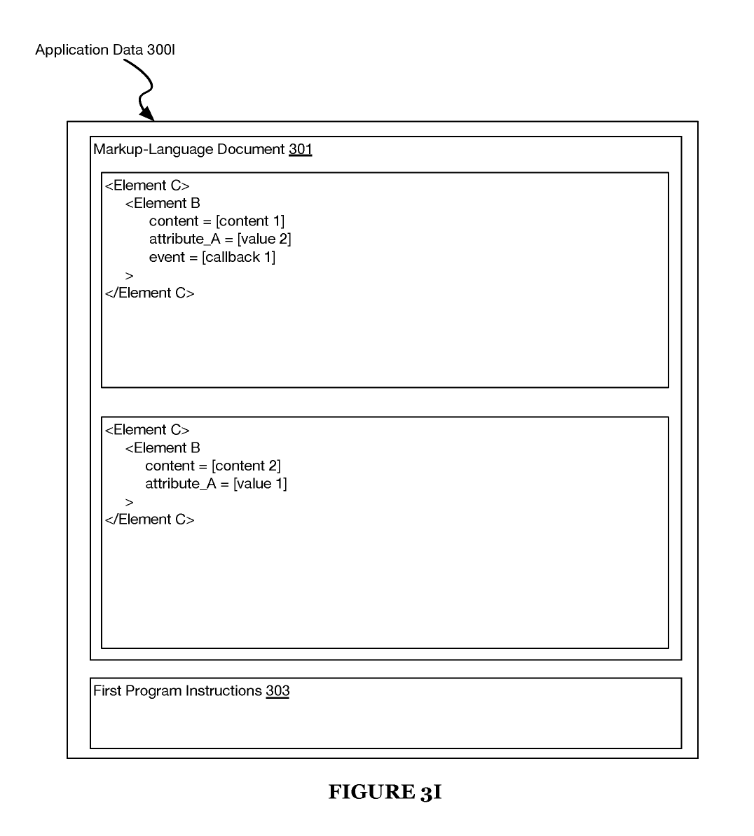

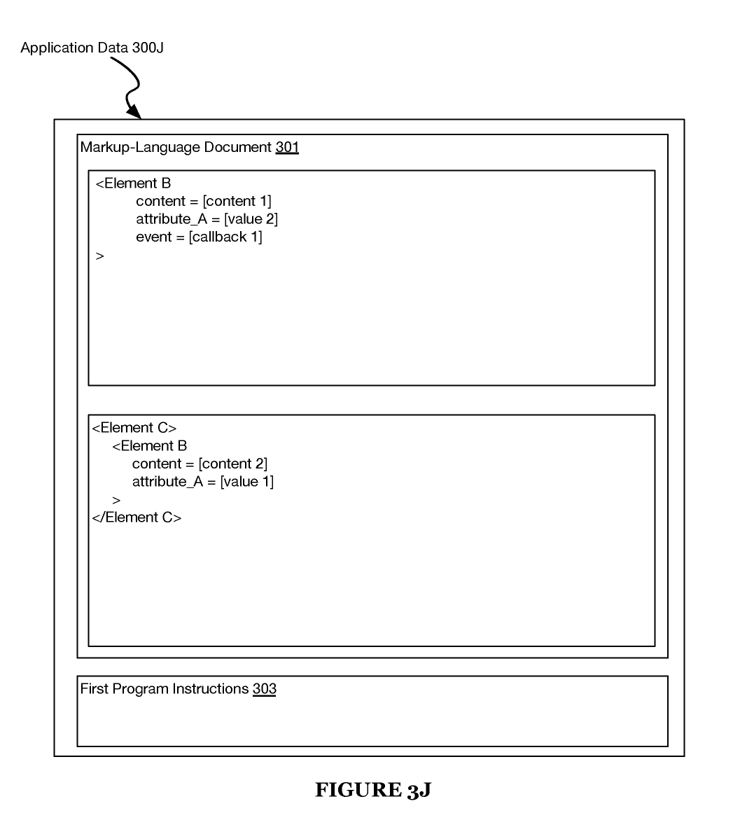

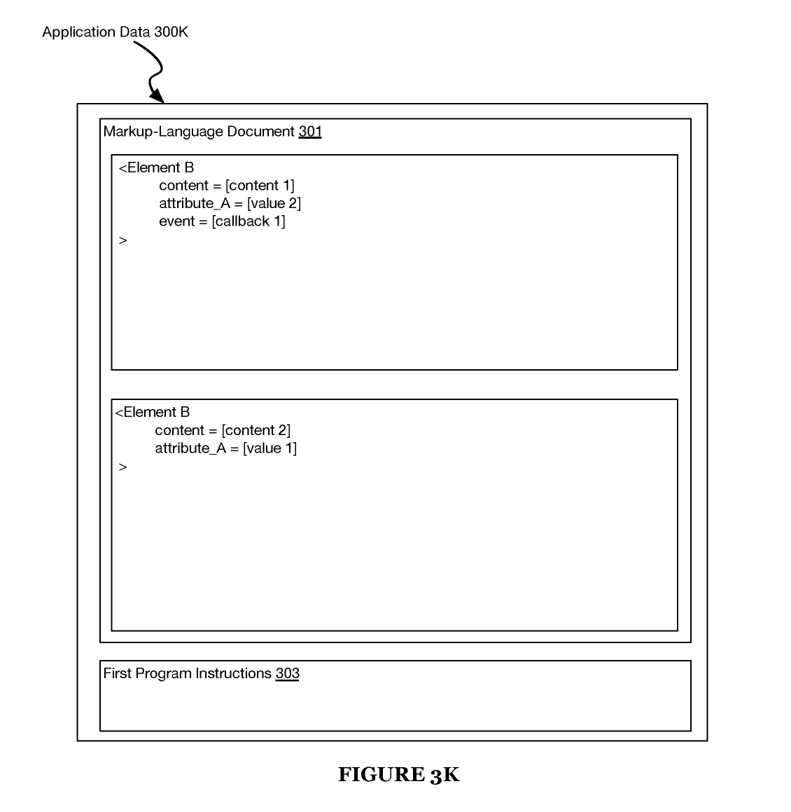

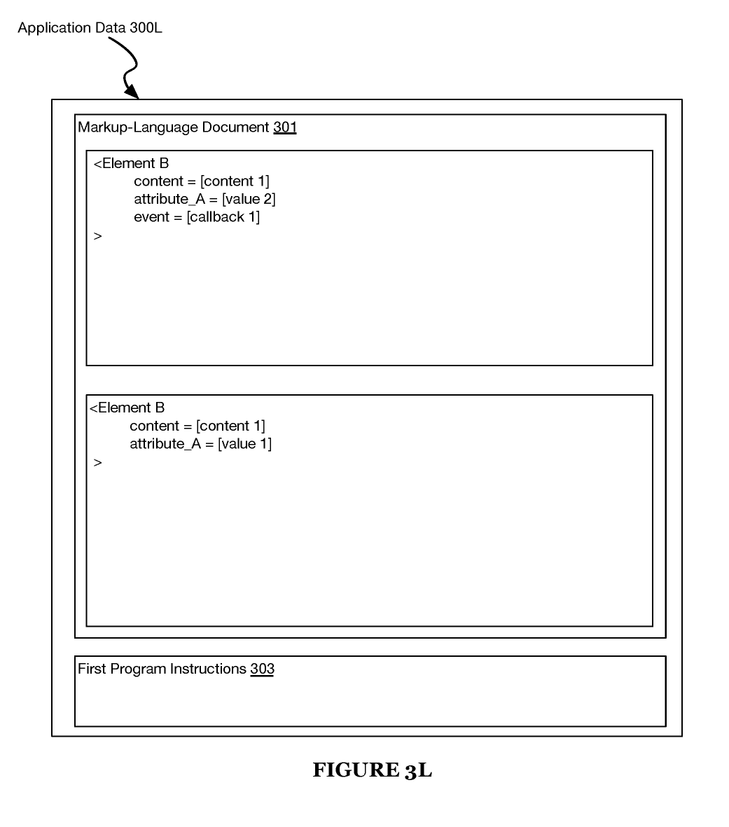

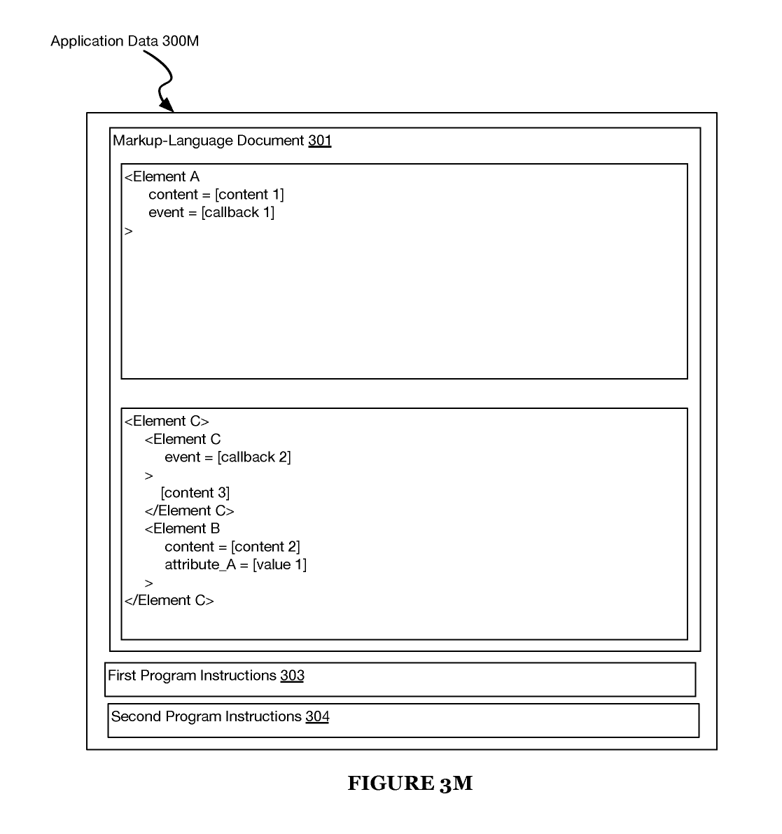

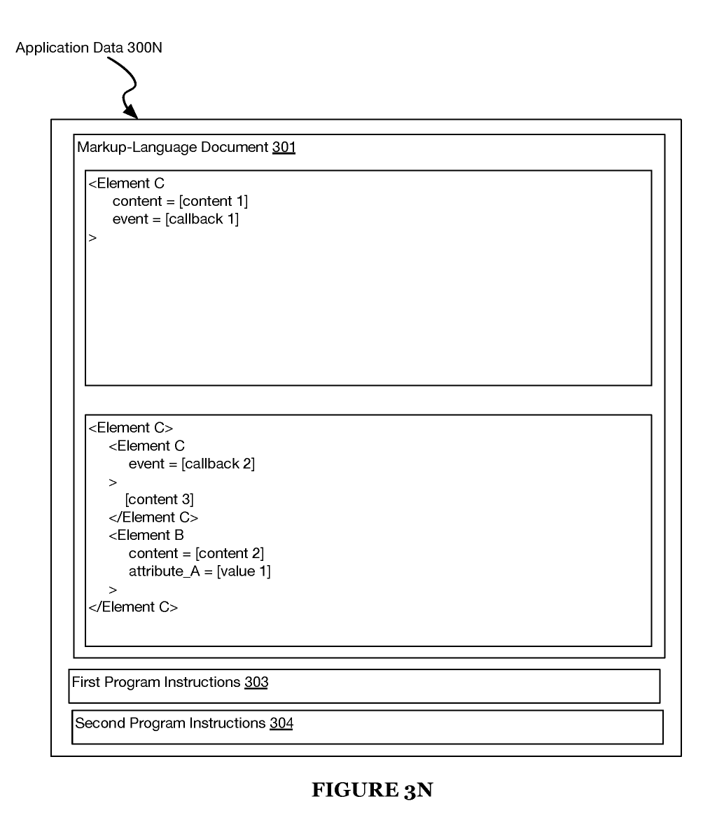

FIGS. 3A-3N depict exemplary application data 300A-300N that include markup-language documents 301 and first program instructions 303.

Returning to FIG. 2, in some embodiments, the first element 210 is a same type of element as the second element 220 (e.g., as shown in 301 of FIG. 3C, 301 of FIG. 3D). In some embodiments, the first element 210 and the second element 220 are different types of elements (e.g., as shown in 301 of FIG. 3A). In some embodiments, the first element 210 includes at least one sub-element (e.g., as shown in 301 of FIG. 3G). In some embodiments, the second element 220 includes at least one sub-element (e.g., as shown in 301 of FIG. 3G). In some embodiments, the first element 210 includes at least one sub-element, and the sub-element of the first element 210 is the same type of element as the second element 220. In some embodiments, the second element 220 includes at least one sub-element, and the sub-element of the second element 220 is the same type of element as the first element 210 (e.g., as shown in 301 of FIG. 3G, 301 of FIG. 3J). In some embodiments, the first element 210 includes at least one sub-element, the second element 220 includes at least one sub-element, the first element 210 is a same type of element as the second element 220, and the sub-element of the first element 210 is a same type as the sub-element of the second element 220 (e.g., as shown in 301 of FIG. 3H). In some embodiments, the first element 210 includes at least one sub-element, the second element 220 includes at least one sub-element, the first element 210 is a same type of element as the second element 220, and the sub-element of the first element 210 and the sub-element of the second element 220 are different types of elements (e.g., as shown in 301 of FIG. 3G).

In some embodiments, the first element 210 includes at least one sub-element, the second element 220 includes at least one sub-element, the first element 210 and the second element 220 are different types of elements, and the sub-element of the first element 210 is a same type as the sub-element of the second element 220. In some embodiments, the first element 210 includes at least one sub-element, the second element 220 includes at least one sub-element, the first element 210 and the second element 220 are different types of elements, and the sub-element of the first element 210 and the sub-element of the second element 220 are different types of elements.

In some embodiments, the first element 210 is an <img> element of an HTML DOM. In some embodiments, the first element 210 is a <div> element of an HTML DOM. In some embodiments, the first element 210 is a <button> element of an HTML DOM. In some embodiments, the first element 210 is a <video> element of an HTML DOM.

In some embodiments, the second element 220 is an <img> element of an HTML DOM. In some embodiments, the second element 220 is a <div> element of an HTML DOM. In some embodiments, the second element 220 is a <button> element of an HTML DOM. In some embodiments, the second element 220 is a <video> element of an HTML DOM.

Returning to FIG. 2, in some embodiments, the first element includes first content 211 and a first mapping 212. In some embodiments, the first mapping 212 is a mapping of a first callback to a first event standard attribute. In some embodiments, the first event standard attribute is an “onclick” attribute of an HTML DOM. In some embodiments, the first callback is a JavaScript callback.

In some embodiments, the second element includes second content 221 and a first standard attribute 222. In some embodiments, the second content 221 is the same as the first content 211 (e.g., as shown in 301 of FIG. 3A, 301 of FIG. 3C). In some embodiments, the second content 221 is different from the first content 211 (e.g., as shown in 301 of FIG. 3B, 301 of FIG. 3D). In some embodiments, the first standard attribute is a standard display attribute of the DOM standard of the DOM.

1. FIGS. 3A-3N: Application Data

FIGS. 3A-3N depict exemplary application data (e.g., the application data 140 of FIG. 1).

FIG. 3A depicts exemplary application data 300A in which the first element (“Element A”) and the second element (“Element B”) are different types of elements, and the first content is the same as the second content (“[content 1]”). The first element includes a mapping of a first callback (“[callback 1]”) to a first event standard attribute (“event”), and the second element specifies a first standard attribute (“attribute_A”) having a first attribute value (“[value 1]”).

FIG. 3B depicts exemplary application data 300B in which the first element (“Element A”) and the second element (“Element B”) are different types of elements, and the first content (“[content 1]”) is different from the second content (“[content 2]”).

FIG. 3C depicts exemplary application data 300C in which the first element (“Element A”) and the second element (“Element A”) are the same type of element, and the first content is the same as the second content (“[content 1]”).

FIG. 3D depicts exemplary application data 300D in which the first element (“Element A”) and the second element (“Element A”) are the same type of element, and the first content (“[content 1]”) is different from the second content (“[content 2]”).

FIG. 3E depicts exemplary application data 300E in which the first element (“Element A”) and the second element (“Element C”) are different types of elements, the first content (“[content 1]”) is the same as the second content (“[content 1]”), the second content is included in a sub-element of the second element, and the sub-element (“Element B”) has a type that is different from the type of the first element and the type of the second element.

FIG. 3F depicts exemplary application data 300F in which the second element includes a first sub-element (“Element B”) and a second sub-element (“Element C”), and the second sub-element includes a mapping of a second callback (“[callback 2]”) to a second event standard attribute (“event”) of the second sub-element. In some embodiments, the second event standard attribute and the first event standard attribute are attributes for a same event. In some embodiments, the second event standard attribute and the first event standard attribute are attributes for different events.

FIG. 3G depicts exemplary application data 300G in which the first element includes a sub-element (“Element B”), and the sub-element of the first element includes the first content and the mapping for the first callback. The application data 300G includes first program instructions 303 for the first callback (“[callback 1”) and second program instructions 304 for a second callback (“[callback 2]”).

FIG. 3H depicts exemplary application data 300H in which the first element includes a sub-element that includes the first standard attribute having a second attribute value (“[value 2]”) that is different from the value of the first standard attribute of the second element.

FIG. 3I depicts exemplary application data 300I in which the first content is different from the second content, the first element includes a sub-element that includes the first standard attribute having a second attribute value (“[value 2]”) that is different from the value of the first standard attribute of the second element.

FIG. 3J depicts exemplary application data 300J in which the first content is different from the second content, and the first element includes the first standard attribute having a second attribute value (“[value 2]”) that is different from the value of the first standard attribute of the second element. As shown in FIG. 3J, the first element does not include a sub-element.

The exemplary application data 300K of FIG. 3K differs from the exemplary application data 300J in that the second element of the application data 300K does not include a sub-element.

The exemplary application data 300L of FIG. 3L differs from the exemplary application data 300K in that the second content of the application data 300L is the same as the first content of the application data 300L.

The exemplary application data 300M of FIG. 3M differs from the exemplary application data 300G of FIG. 3G in that the second content of the application data 300M is different from the first content of the application data 300M, the first element of the application data 300M does not include a sub-element, and the first element of the application data 300M and the second element of the application data 300M are different types of elements.

The exemplary application data 300N of FIG. 3N differs from the exemplary application data 300M of FIG. 3M in that the first element of the application data 300N and the second element of the application data 300N are a same types of element.

### Methods

2. Method 400: Application Developer System

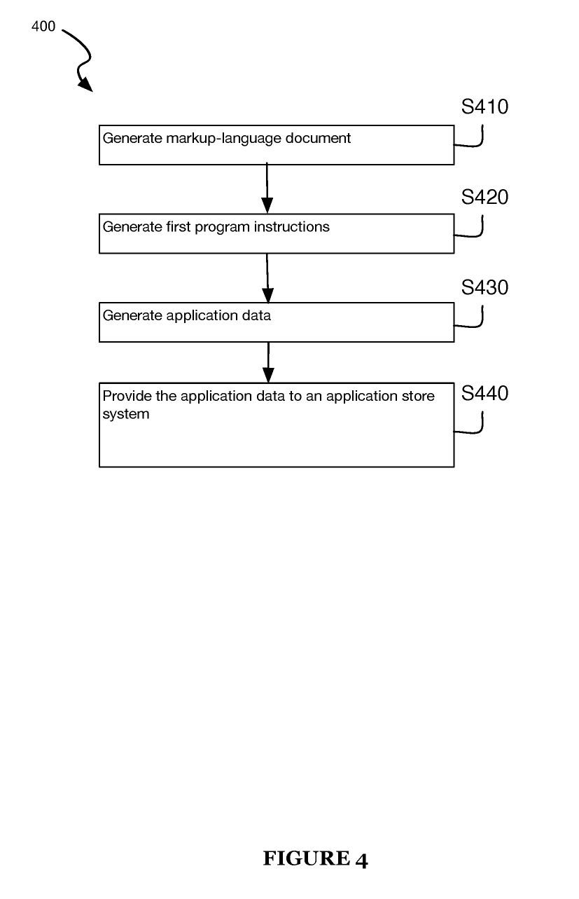

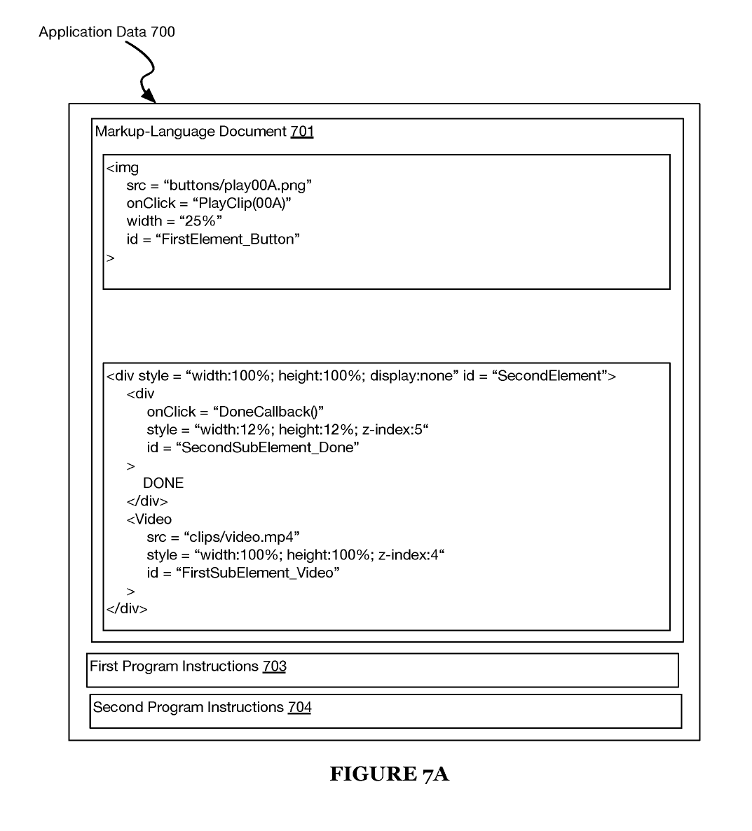

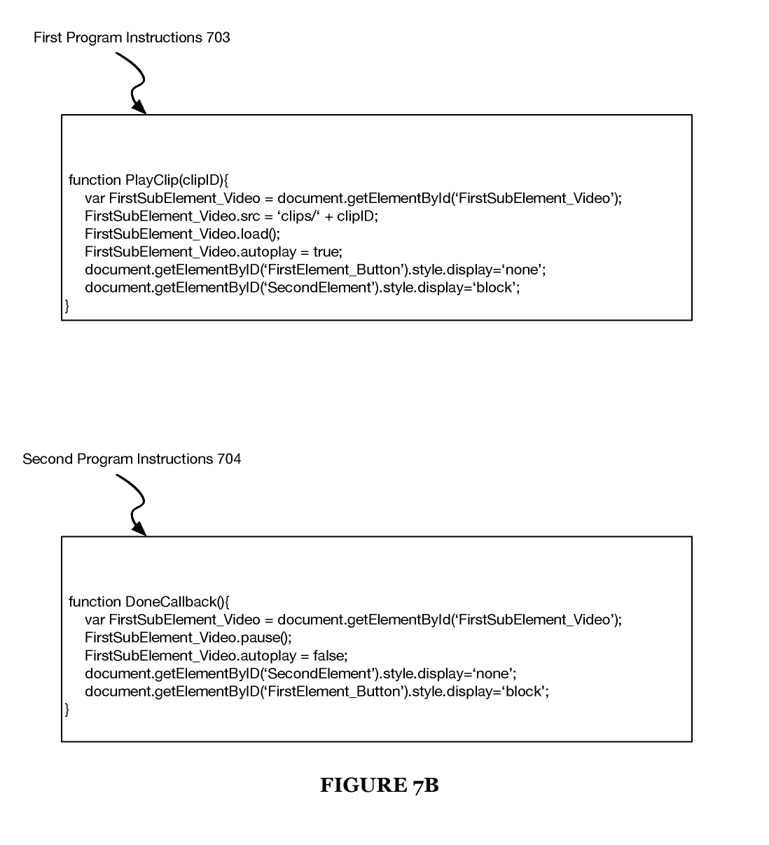

FIG. 4 is a representation of a method 400, according to embodiments. In some embodiments, method 400 includes: an application developer system (e.g., 110 of FIG. 1) generating a markup-language document (e.g., 201 of FIG. 2, 301 of FIGS. 3A-N, 701 of FIG. 7A) that includes a visible first element (e.g., 210 of FIG. 2) and a hidden second element (e.g., 220 of FIG. 2) (process S410); the application developer system generating first program instructions (e.g., 202 of FIG. 2, 303 of FIGS. 3A-3N, 703 of FIG. 7A) (process S420); the application developer system generating application data (e.g., 140 of FIG. 1) that includes the markup-language document and the first program instructions (process S430); and the application developer system providing the application data to an application store system (e.g., 120 of FIG. 1) via a network (e.g., the Internet) (process S440). The first element specifies first content (e.g., 211 of FIG. 2), and a mapping (e.g., 212 of FIG. 2) of a first callback to a first event standard attribute. The second element specifies second content (e.g., 221 of FIG. 2) and a first standard attribute (e.g., 222 of FIG. 2) having a first attribute value. The generated first program instructions are program instructions for the first callback. The first program instructions include instructions for controlling a presentation engine (e.g., 1115 of FIG. 11) of a mobile device (e.g., 130 of FIG. 1) to hide the first element and display the second element during rendering of the markup-language document by the presentation engine by using a document object model (DOM) (e.g., 1116 of FIG. 11) for the markup language. The first element and the second element are standard elements of the DOM, and the first standard attribute is a standard attribute of the DOM. In some embodiments, the application store system provides the application data to the mobile device via the network.

3. Generation of the Markup-Language Document

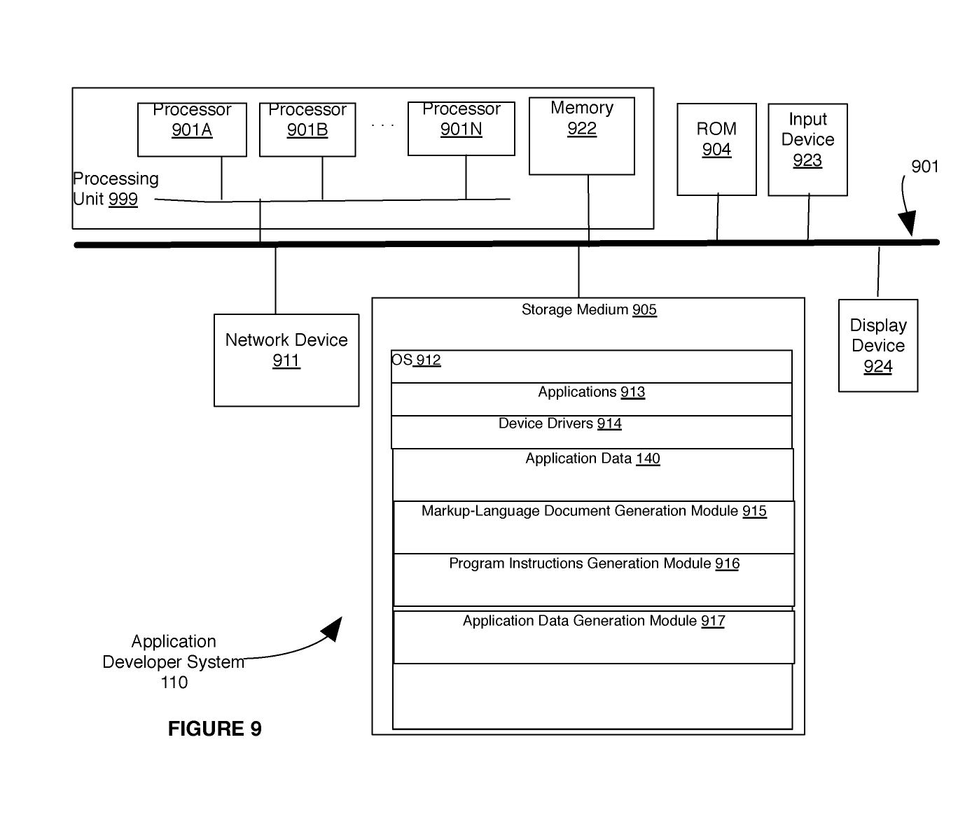

In some embodiments, the application developer system generates the markup-language document responsive to user-input received via a user input-device (e.g., 923 of FIG. 9) of the application developer system.

In some embodiments, the application developer system stores a markup-language document generation module (e.g., 915 of FIG. 9) that includes machine-executable program instructions that (when executed by the application developer system) control the application developer system to generate the markup-language document.

In some embodiments, the application developer system stores a markup-language document generation module (e.g., 915 of FIG. 9) that includes machine-executable program instructions that (when executed by the application developer system) control the application developer system to generate the markup-language document, and the application developer system generates the markup-language document responsive to execution of the instructions of the markup-language document generation module. In some embodiments, at least a first portion of the markup-language document is received via a user input-device (e.g., 923 of FIG. 9) of the application developer system, and a second portion of the markup-language document is generated by the application developer system based on information received via the user-input device. In some embodiments, the markup-language document generation module is a compiler. In some embodiments, the markup-language document generation module is an IDE (Integrated Development Environment). In some embodiments, the markup-language document generation module is the Apache Cordova cross-platform development framework. In some embodiments, the markup-language document generation module includes at least one library.

In some embodiments, the application developer system is constructed to generate the markup-language document by displaying a graphical user interface on the display device 924, receiving user selection of a user interface element of the graphical user interface, and generating at least one markup-language element based on the received user selection. In some embodiments, the application developer system is constructed to generate the markup-language document by displaying a graphical user interface on the display device 924, receiving user selection of a user interface element of the graphical user interface, and generating at least one markup-language attribute based on the received user selection.

In some embodiments, the application developer system is constructed to generate the markup-language document by receiving user-selection information of user interface elements of a graphical user interface displayed on a display device of the application developer system, and generating the markup-language document by converting the received user-selection information into at least one element and attribute of the markup language document.

4. Generation of the Program Instructions

In some embodiments, the application developer system generates the first program instructions responsive to user-input received via a user input-device (e.g., 923 of FIG. 9) of the application developer system.

In some embodiments, the application developer system stores a program instructions generation module (e.g., 916 of FIG. 9) that includes machine-executable program instructions that (when executed by the application developer system) control the application developer system to generate the first program instructions.

In some embodiments, the application developer system stores a program instructions generation module (e.g., 916 of FIG. 9) that includes machine-executable program instructions that (when executed by the application developer system) control the application developer system to generate the first program instructions, and the application developer system generates the first program instructions responsive to execution of the instructions of the program instructions generation module. In some embodiments, at least a first portion of the first program instructions is received via a user input-device (e.g., 923 of FIG. 9) of the application developer system, and a second portion of the first program instructions is generated by the application developer system based on information received via the user-input device. In some embodiments, the program instructions generation module is a compiler. In some embodiments, the program instructions generation module is an IDE (Integrated Development Environment). In some embodiments, the program instructions generation module is the Apache Cordova cross-platform development framework. In some embodiments, the program instructions generation module includes at least one code library.

In some embodiments, the application developer system is constructed to generate the first program instructions by displaying a graphical user interface on the display device 924, receiving user selection of a user interface element of the graphical user interface, and generating at least one program instruction based on the received user selection.

In some embodiments, the application developer system is constructed to generate the second program instructions described herein (e.g., 704 of FIG. 7B) by displaying a graphical user interface on the display device 924, receiving user selection of a user interface element of the graphical user interface, and generating at least one program instruction based on the received user selection.

In some embodiments, the application developer system is constructed to generate the first program instructions by receiving user-selection information of user interface elements of a graphical user interface displayed on a display device of the application developer system, and generating the first program instructions by converting the received user-selection information into at least one program instruction.

In some embodiments, the application developer system is constructed to generate the second program instructions described herein by receiving user-selection information of user interface elements of a graphical user interface displayed on a display device of the application developer system, and generating the second program instructions by converting the received user-selection information into at least one program instruction.

5. Generation of the Application Data

In some embodiments, the application developer system generates the application data responsive to user-input received via a user input-device (e.g., 923 of FIG. 9) of the application developer system.

In some embodiments, the application developer system stores an application data generation module (e.g., 917 of FIG. 9) that includes machine-executable program instructions that (when executed by the application developer system) control the application developer system to generate the application data.

In some embodiments, the application developer system stores an application data generation module (e.g., 917 of FIG. 9) that includes machine-executable program instructions that (when executed by the application developer system) control the application developer system to generate the application data, and the application developer system generates the application data responsive to execution of the instructions of the application data generation module. In some embodiments, at least a first portion of the application data is received via a user input-device (e.g., 923 of FIG. 9) of the application developer system, and a second portion of the application data is generated by the application developer system based on information received via the user-input device. In some embodiments, the application data generation module is a compiler. In some embodiments, the application data generation module is an IDE (Integrated Development Environment). In some embodiments, the application data generation module is the Apache Cordova cross-platform development framework. In some embodiments, the application data generation module includes at least one code library.

6. Method 500: Application Store System

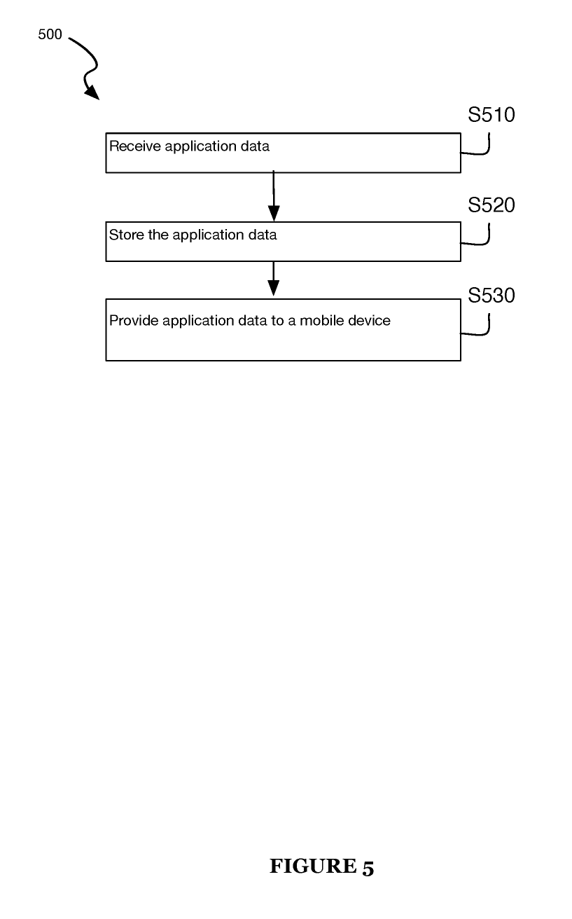

FIG. 5 is a representation of a method 500, according to embodiments. In some embodiments, method 500 includes: an application store system (e.g., 120 of FIG. 1) receiving from an application developer system (e.g., 110 of FIG. 1) application data (e.g., 140 of FIG. 1) that includes a markup-language document (e.g., 201 of FIG. 2) and first program instructions (e.g., 202 of FIG. 2) (process S510); the application store system storing the application data (process S520); and responsive to a request received by the application store system from a mobile device (e.g., 130 of FIG. 1), the application store system providing the stored application data to the mobile device (process S530). The markup-language document includes a visible first element and a hidden second element. The first element specifies: first content, a mapping of a first callback to a first event standard attribute. The second element specifies: second content, and a first standard attribute having a first attribute value. The first program instructions include program instructions for the first callback, the program instructions for the first callback include instructions for controlling a presentation engine of a mobile device to hide the first element and display the second element during rendering of the markup-language document by the presentation engine by using a document object model (DOM) for the markup language. The first element and the second element are standard elements of the DOM, and the first standard attribute is a standard attribute of the DOM.

7. Method 600: Mobile Device

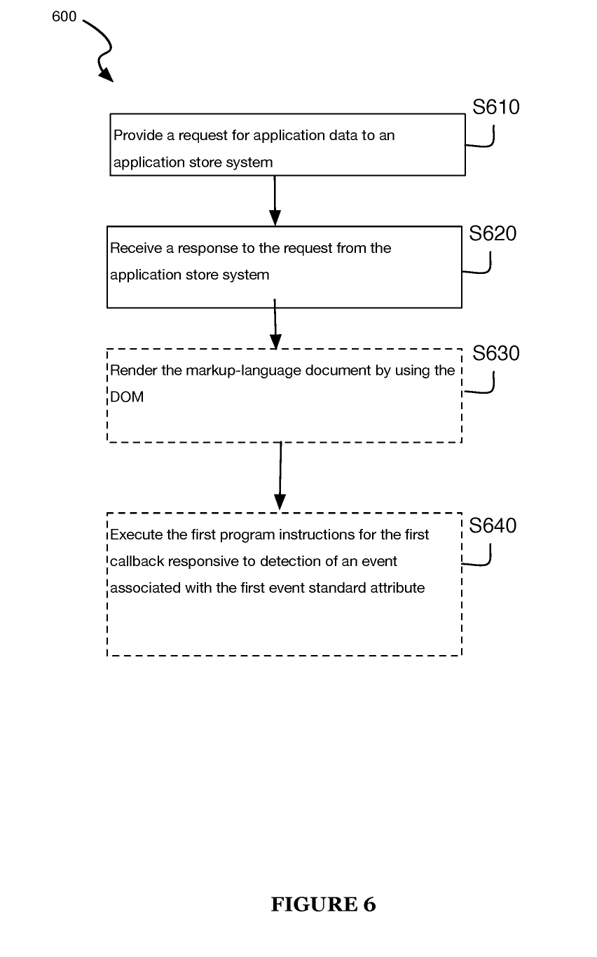

FIG. 6 is a representation of a method 600, according to embodiments. In some embodiments, method 600 includes: a mobile device (e.g., 130 of FIG. 1) providing a request for application data (e.g., 140 of FIG. 1) to an application store system (e.g., 120 of FIG. 1) (process S610); the mobile device receiving a response to the request from the application store system, the response including the application data, and the application data including a markup-language document (e.g., 201 of FIG. 2) and first program instructions (e.g., 202 of FIG. 2) (process S620). The markup-language document includes a visible first element and a hidden second element. The first element specifies: first content, a mapping of a first callback to a first event standard attribute. The second element specifies: second content, and a first standard attribute having a first attribute value. The first program instructions include program instructions for the first callback, the program instructions for the first callback include instructions for controlling a presentation engine of a mobile device to hide the first element and display the second element during rendering of the markup-language document by the presentation engine by using a document object model (DOM) for the markup language. The first element and the second element are standard elements of the DOM, and the first standard attribute is a standard attribute of the DOM.

In some embodiments, the method 600 further includes: the presentation engine of the mobile device rendering the markup-language document by using the DOM (process S630).

In some embodiments, the method 600 further includes: the mobile device executing the first program instructions for the first callback responsive to detection of an event associated with the first event standard attribute (process S640), wherein the mobile device executing the first program instructions includes: the presentation engine of the mobile device hiding the first element and displaying the second element during rendering of the markup-language document by the presentation engine.

8. Displaying, Hiding and Standard Display Attribute

In some embodiments, the first program instructions (e.g., 202 of FIG. 2) include instructions for controlling the presentation engine (e.g., 1115 of FIG. 11) of the mobile device (e.g., 130 of FIG. 1) to hide the first element (e.g., 210 of FIG. 2) by modifying a value of a standard display attribute of the first element by using the DOM (e.g., 1116 of FIG. 11), the first program instructions include instructions for controlling the presentation engine to display the second element (e.g., 220 of FIG. 2) by modifying a value of a standard display attribute of the second element by using the DOM, the standard display attribute of the first element is different from the first standard attribute, and the standard display attribute of the second element is different from the first standard attribute.

In some embodiments, the standard display attribute of the first element is a “display” attribute of an HTML DOM, the standard display attribute of the second element is a “display” attribute of an HTML DOM, the first program instructions include instructions for controlling the presentation engine of the mobile device to hide the first element by modifying a value of a “display” attribute of the first element by using the HTML DOM, and the first program instructions include instructions for controlling the presentation engine to display the second element by modifying a value of a “display” attribute of the second element by using the HTML DOM.

In some embodiments, the standard display attribute of the first element is a “display” attribute of an HTML DOM, the standard display attribute of the second element is a “display” attribute of an HTML DOM, the first program instructions include instructions for controlling the presentation engine of the mobile device to hide the first element by setting the “display” attribute of the first element to a “none” value by using the HTML DOM, and the first program instructions include instructions for controlling the presentation engine to display the second element by modifying a “none” value of the “display” attribute of the second element to a different value (e.g., “block”, “inline”, “table) by using the HTML DOM.

9. First Standard Attribute

In some embodiments, the first standard attribute (e.g., 222 of FIG. 2, “attribute_A” of FIGS. 3A-3N) is a standard display dimension attribute of the DOM, and the second element (e.g., 220 of FIG. 2) is displayed in accordance with the first attribute value (e.g., “[value 1]” of FIGS. 3A-3N) of the second element. In some embodiments, the first attribute value (e.g., “[value 1]” of FIGS. 3A-3N) is one of a height value and a width value. In some embodiments, the first standard attribute (e.g., 222 of FIG. 2, “attribute_A” of FIGS. 3A-3N) is a width attribute of the DOM, and the DOM is an HTML DOM. In some embodiments, the first standard attribute is a height attribute of the DOM, and the DOM is an HTML DOM. In some embodiments, the first standard attribute is a Z-index attribute of the DOM, and the DOM is an HTML DOM. In some embodiments, the first standard attribute is a background-color attribute of the DOM, and the DOM is an HTML DOM. In some embodiments, the first standard attribute is a style attribute of the DOM, and the DOM is an HTML DOM. In some embodiments, the first standard attribute is a style attribute of the DOM having a width value, and the DOM is an HTML DOM. In some embodiments, the first standard attribute is a style attribute of the DOM having a height value, and the DOM is an HTML DOM. In some embodiments, the first standard attribute is a style attribute of the DOM having a height value and a width value, and the DOM is an HTML DOM.

10. First Event Attribute

In some embodiments, the first event standard attribute (e.g., “event” of FIGS. 3A-3N) is an attribute for a user interaction event associated with user interaction for the first element (e.g., 210 of FIG. 2), and the first event standard attribute is a standard attribute of the DOM. In some embodiments, the first event standard attribute is an “onclick” attribute of the DOM. In some embodiments, the first event standard attribute is an “onclick” attribute of the DOM, and the DOM is an HTML DOM.

11. Second Element Callback

In some embodiments, the second element (e.g., 220 of FIG. 2) specifies a mapping (e.g., “event=[callback 2]” of FIGS. 3F, 3G, 3M, and 3N, “onClick=“DoneCallback( )” of FIG. 7A) of a second callback (e.g., “[callback 2]” of FIGS. 3F, 3G, 3M, and 3N, “DoneCallback( )” of FIG. 7A) to a second event standard attribute for a user interaction event associated with user interaction for the second element. In some embodiments, the method 400 further includes: the application developer system (e.g., 110 of FIG. 1) generating second program instructions (e.g., 304 of FIGS. 3F, 3G, 3M, and 3N, 704 of FIGS. 7A and 7B) for the second callback (e.g., “[callback 2]” of FIGS. 3F, 3G, 3M, and 3N, “DoneCallback( )” of FIG. 7A). The second program instructions include instructions for controlling the presentation engine (e.g., 1115 of FIG. 11) to hide the second element (e.g., 220 of FIG. 2) and display the first element (e.g., 210 of FIG. 2) during rendering of the markup-language document (e.g., 201 of FIG. 2) by using the DOM (e.g., 1116 of FIG. 11). In some embodiments, the application data (e.g., 140 of FIG. 1) includes the markup-language document (e.g., 201 of FIG. 2, 301 of FIGS. 3F, 3G, 3M, and 3N, 701 of FIG. 7A), the first program instructions (e.g., 202 of FIG. 2, 303 of FIGS. 3F, 3G, 3M, and 3N, 703 of FIGS. 7A and 7B), and the second program instructions (e.g., 304 of FIGS. 3F, 3G, 3M, and 3N, 704 of FIGS. 7A and 7B).

In some embodiments, the second event standard attribute (of the second callback of the second element) is a standard attribute of the DOM. In some embodiments, the second event standard attribute is an “onclick” attribute of the DOM. In some embodiments, the second event standard attribute is an “onclick” attribute of the DOM, and the DOM is an HTML DOM.

12. First Content and Second Content

In some embodiments, the first content (e.g., 211 of FIG. 2) is different from the second content (e.g., 221 of FIG. 2), the second element (e.g., 221 of FIG. 2) includes a first sub-element that specifies the second content, and the second element includes a second sub-element that specifies the mapping of the second callback to the second event standard attribute (e.g., as shown in FIG. 3N).

In some embodiments, the first content is the same as the second content. In some embodiments, the first content is substitute content for the second content. In some embodiments, the second element includes a reference to the second content. In some embodiments, the first element includes a first sub-element that specifies the first content (e.g., as shown in FIG. 3I). In some embodiments, the second element includes a first sub-element that specifies the second content (e.g., as shown in FIG. 3I).

In some embodiments, the first content is video content. In some embodiments, the first content is image content. In some embodiments, the first content is audio content. In some embodiments, the first content is text content.

In some embodiments, the second content is video content. In some embodiments, the second content is image content. In some embodiments, the second content is audio content. In some embodiments, the second content is text content.

In some embodiments, the first content is image content and the second content is video content. In some embodiments, the first content is image content and the second content is audio content. In some embodiments, the first content is image content and the second content is image content. In some embodiments, the first content is image content and the second content is text content.

In some embodiments, the first content is video content and the second content is video content. In some embodiments, the first content is video content and the second content is audio content. In some embodiments, the first content is video content and the second content is image content. In some embodiments, the first content is video content and the second content is text content.

In some embodiments, the first content is audio content and the second content is video content. In some embodiments, the first content is audio content and the second content is audio content. In some embodiments, the first content is audio content and the second content is image content. In some embodiments, the first content is audio content and the second content is text content.

In some embodiments, the first content is text content and the second content is video content. In some embodiments, the first content is text content and the second content is audio content. In some embodiments, the first content is text content and the second content is image content. In some embodiments, the first content is text content and the second content is text content.

13. Playing Video Clips

In some embodiments, the first program instructions (e.g., 202 of FIG. 2, 703 of FIGS. 7A and 7B) include instructions for controlling the presentation engine (e.g., 1115 of FIG. 11) of the mobile device (e.g., 130 of FIG. 1) to: select a video clip from a plurality of video clips stored on a storage device (e.g., 1105 of FIG. 11) of the mobile device; set the selected video clip as a video source of the second element; load the selected video clip; play the selected video clip; and set a standard display attribute of the second element to a visible value by using the DOM (e.g., 1116 of FIG. 11).

14. First Element and Second Element

In some embodiments, first element is an element of a first type and the second element is an element of a different type (e.g., as shown in FIG. 3A).

In some embodiments, the first element specifies the first standard attribute (e.g., “attribute_A” of FIG. 3H) having a second attribute value (e.g., “[value 2]” of FIG. 3H) different from the first attribute value (e.g., “[value 1] of FIG. 3H) of the second element, and the first element is displayed in accordance with the second attribute value of the first standard attribute of the first element.

15. Mobile Device

In some embodiments, the mobile device (e.g., 130 of FIG. 1) executes the first program instructions for the first callback (e.g., “callback” 1” of FIGS. 3A-3N) responsive to detection of an event associated with the first event standard attribute. In some embodiments, the mobile device executes the second program instructions for the second callback (e.g., “[callback 2]” of FIGS. 3F, 3G, 3M, and 3N) responsive to detection of an event associated with the second event standard attribute. In some embodiments, a display device displays the second content. In some embodiments, the mobile device includes the display device. In some embodiments, the mobile device is communicatively coupled to the display device and the display device is external to the mobile device.

In some embodiments, the presentation engine (e.g., 1115 of FIG. 11) is constructed to process the markup-language document (e.g., 201 of FIG. 2, 301 of FIGS. 3A-3N, 701 of FIG. 7A) in accordance with the DOM (e.g., 1116 of FIG. 11). In some embodiments, the presentation engine is constructed to execute the first program instructions for the first callback. In some embodiments, the presentation engine is constructed to execute the second program instructions for the first callback. In some embodiments, the presentation engine is constructed to render the markup-language document in accordance with style definitions included in the markup-language document (e.g., “style” of FIG. 7A).

In some embodiments, the mobile device executes the first program instructions in an offline mode during which the mobile device is disconnected from the network, and the mobile device stores the first content, the second content, the markup-language document, and the first program instructions.

16. Video Application

In some embodiments, the application data (e.g., 140 of FIG. 1) is application data for a video application. In some embodiments, the video application is a mobile video application. In some embodiments, the video application is a video tour guide application. In some embodiments, the video application is a mobile video tour guide application.

FIGS. 7A and 7B depict an exemplary application data 700 in which the first element (“id=FirstElement_Button”) of the markup-language document 701 is an image element and the second element (“id=SecondElement”) is a div that includes a div sub-element and a video sub-element. The first content is a reference to an image of a button (“play00A.png”). The mapping of the first element is a mapping of a user click event attribute (“onClick”) to a first callback for playing a video clip (“PlayClip(00A)”). The second element includes the div sub-element and the video sub-element. The div sub-element includes a mapping of a user click event attribute (“onClick”) to a second callback for ending playback of the video clip (“DoneCallback( )”). The video sub-element includes the second content, which is a reference to a video file (“clips/video.mp4”). The video sub-element includes the first standard attribute (“style”) having a first attribute value (“width:100%; height:100%; z-index:4”).

In some embodiments, the first element includes a display attribute that is set to a value for display of the first element. In some embodiments, the first element includes a display attribute that is set to a value that is different from a “none” value.

In some embodiments, the second element includes a display attribute (e.g., “display:none” of FIG. 7A) that is set to a value for hiding the second element. In some embodiments, the second element includes a display attribute that is set to a “none” value.

FIG. 7B depicts exemplary first program instructions 703 and exemplary second program instructions 704. As shown in FIG. 7B, the first program instructions 703 include program instructions for controlling the presentation engine to hide the first element (“document.getElementByID(‘FirstElement_Button’).style.display=‘none’;”). As shown in FIG. 7B, the first program instructions 703 include program instructions for controlling the presentation engine to display the second element (“document.getElementByID(‘SecondElement’).style.display=‘block’;”).

As shown in FIG. 7B, the first program instructions 703 include program instructions for controlling the presentation engine to select a video clip from a plurality of video clips stored on a storage device of the mobile device, and set the selected clip as a video source of the second element (“FirstSubElement_Video.src=‘clips/’+clipID”). As shown in FIG. 7B, the first program instructions 703 include program instructions for controlling the presentation engine to load the selected video clip (“FirstSubElement_Video.load( )”). As shown in FIG. 7B, the first program instructions 703 include program instructions for controlling the presentation engine to play the selected video clip (“FirstSubElement_Video.play( )”). As shown in FIG. 7B, the first program instructions 703 include program instructions for controlling the presentation engine to set a standard display attribute of the second element to a visible value by using the DOM (“document.getElementByID(‘SecondElement’).style.display=‘block’;”).

As shown in FIG. 7B, the second program instructions 704 include program instructions for controlling the presentation engine to hide the second element (“document.getElementByID(‘SecondElement’).style.display=‘none’;”). As shown in FIG. 7B, the second program instructions 704 include program instructions for controlling the presentation engine to display the first element (“document.getElementByID(‘FirstElement_Button’).style.display=‘block’;”). As shown in FIG. 7B, the second program instructions 704 include program instructions for controlling the presentation engine to stop playing the video clip of the video sub-element (“FirstSubElement_Video.pause( ); FirstSubElement_Video.autoplay=false;”).

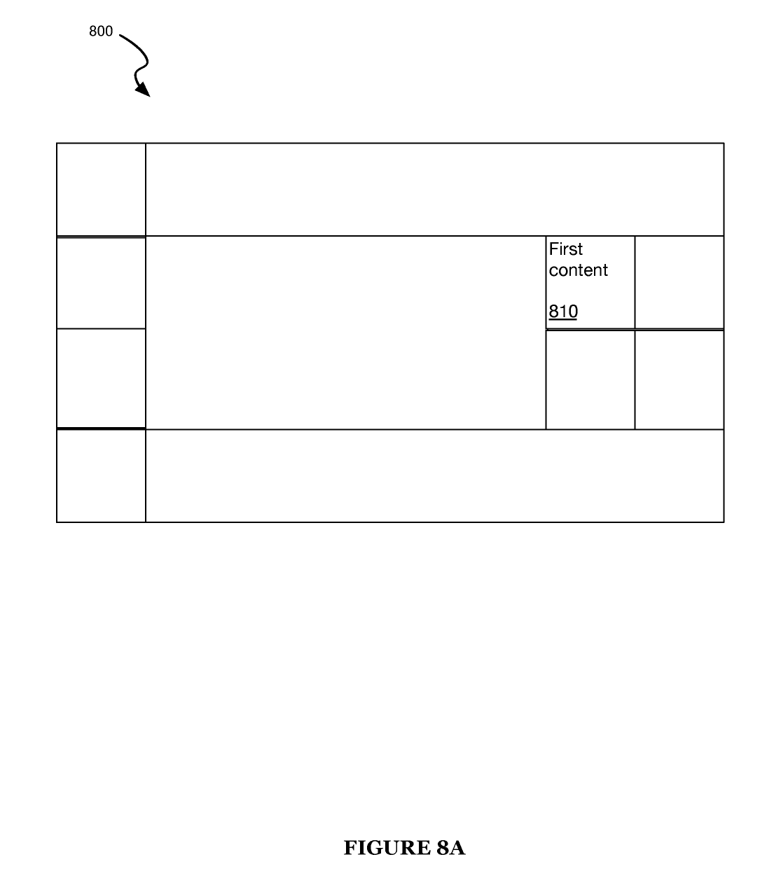

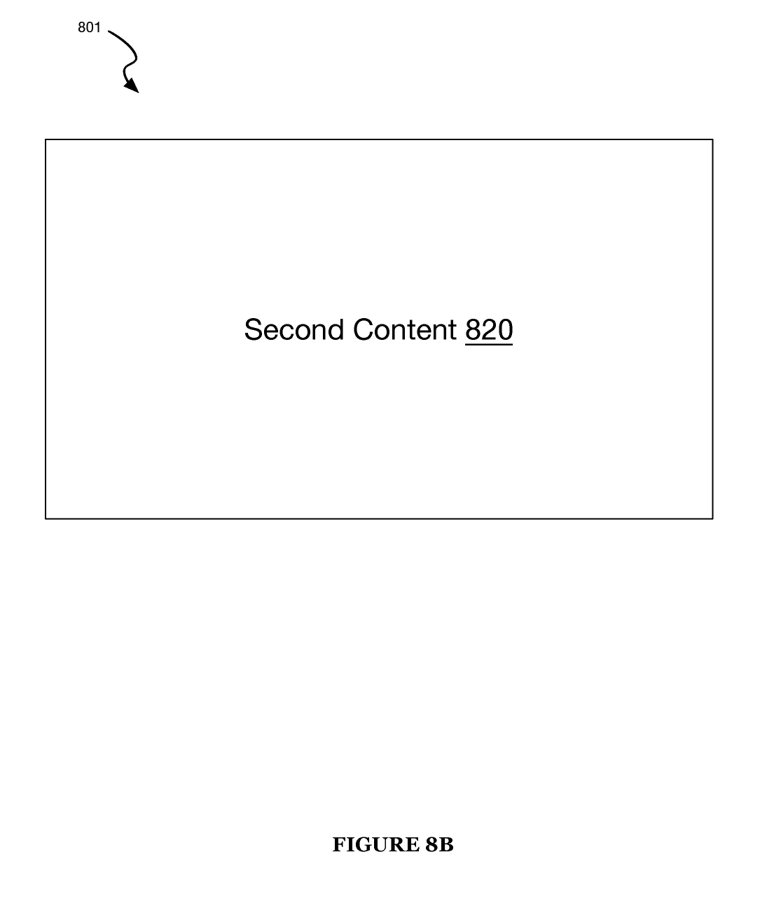

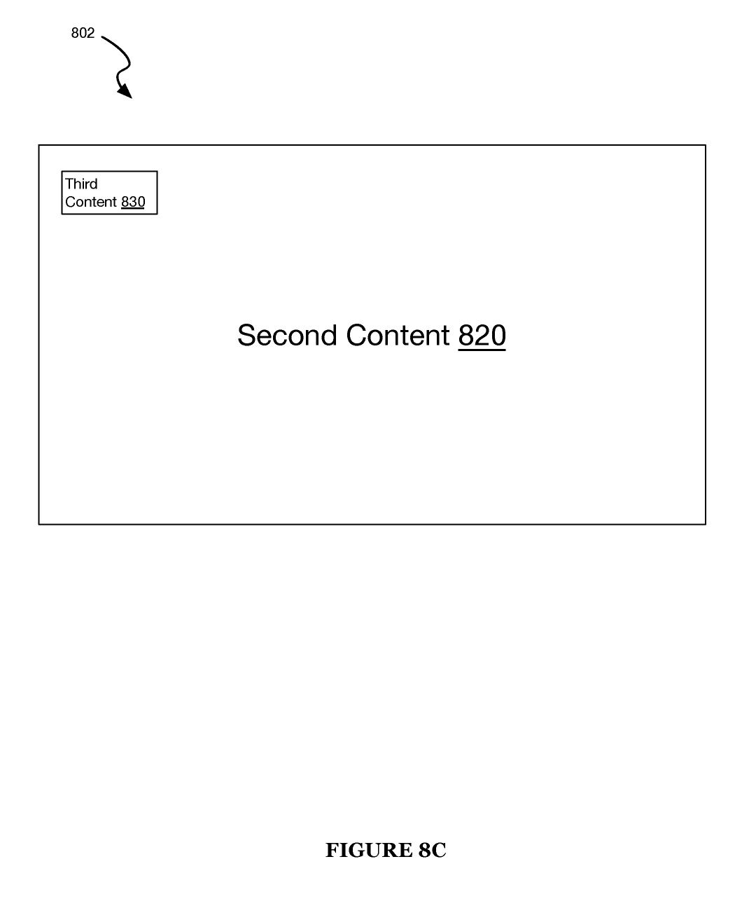

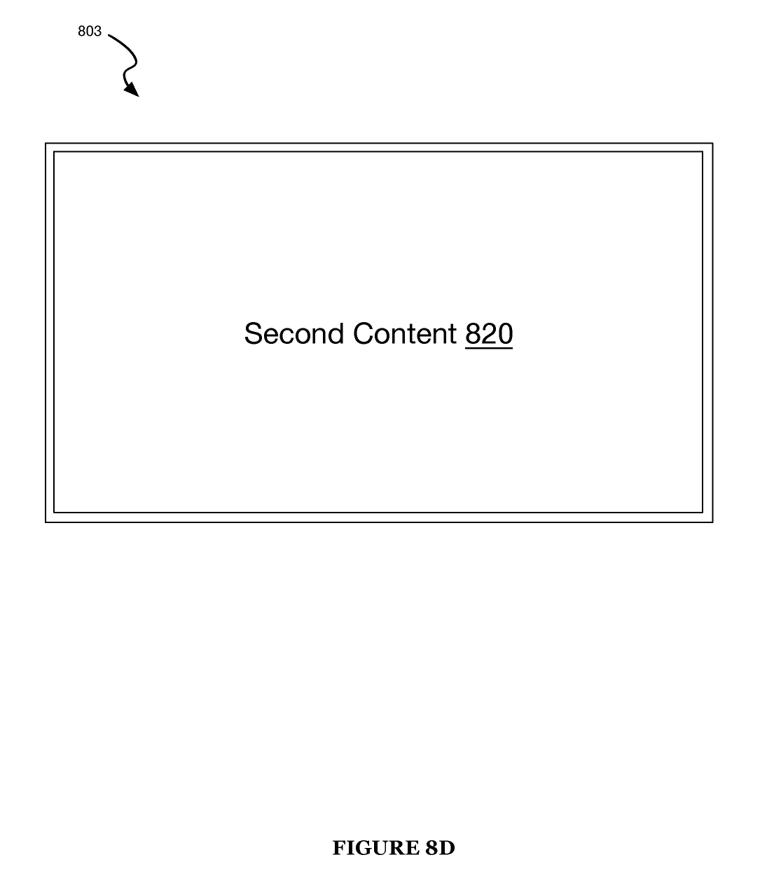

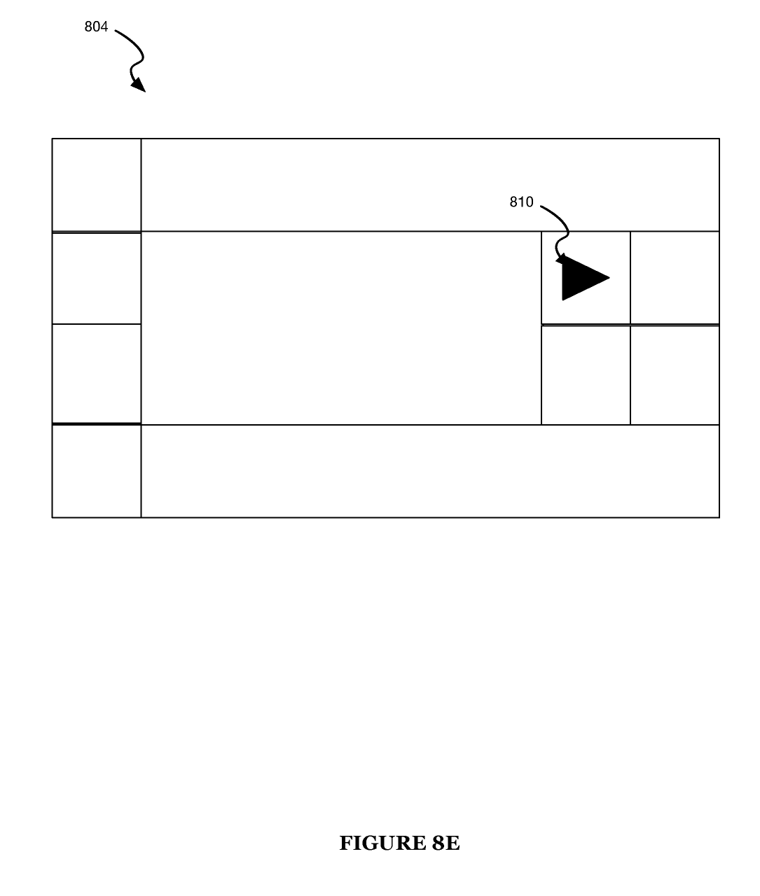

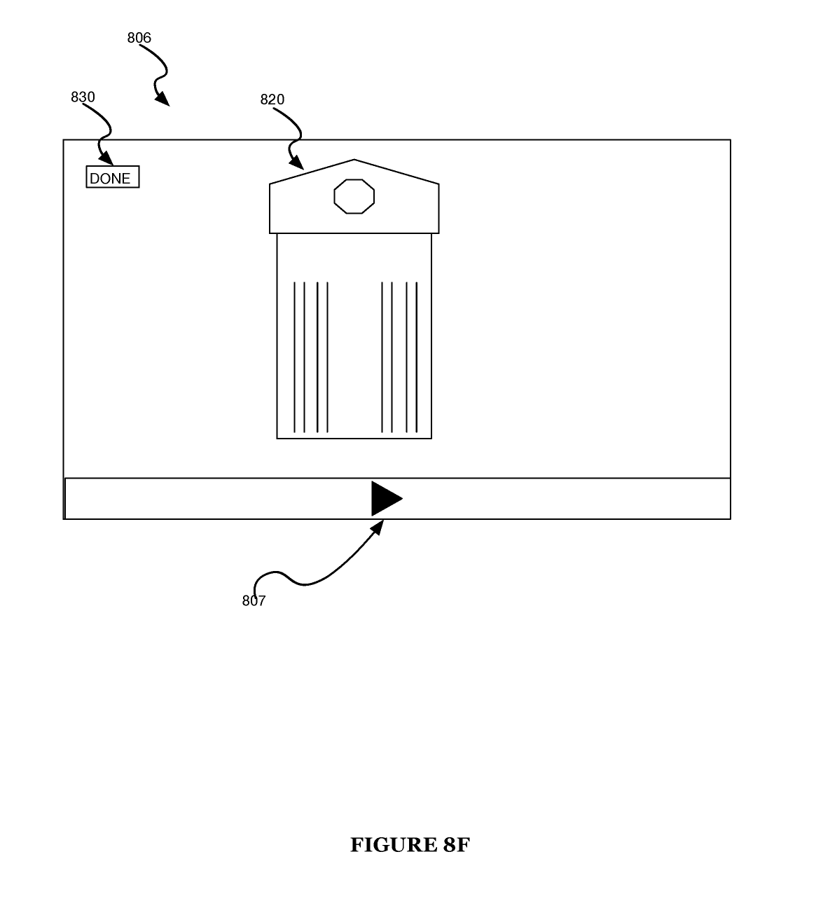

FIG. 8A depicts an exemplary rendering 800 of the markup-language document (e.g., 201 of FIG. 2) at the mobile device (e.g., 130 of FIG. 1) prior to execution of the first program instructions by the mobile device. As shown in FIG. 8A, the first content 810 is displayed, but the second content is not displayed.

FIG. 8B depicts an exemplary rendering 801 of the markup-language document (e.g., 201 of FIG. 2) at the mobile device (e.g., 130 of FIG. 1) during execution of the first program instructions by the mobile device. As shown in FIG. 8B, the first content 810 (of FIG. 8A) is not displayed, but the second content 820 is displayed. As shown in FIG. 8B, the second content occupies the entire display area. In some embodiments, the width and height display values for the second content 820 are both 100%.

FIG. 8C depicts an exemplary rendering 802 of the markup-language document (e.g., 201 of FIG. 2) at the mobile device (e.g., 130 of FIG. 1) during execution of the first program instructions by the mobile device. As shown in FIG. 8C, the first content 810 is not displayed, but the second content 820 is displayed and a third content 830 is also displayed. As depicted in FIG. 8C, the third content 830 is displayed on top of the second content. In some embodiments, the third content 830 is displayed in a layer that is above a layer of the second content. As shown in FIG. 8C, the second content occupies the entire display area. In some embodiments, the width and height display values for the second content 820 are both 100%.

FIG. 8D depicts an exemplary rendering 803 of the markup-language document (e.g., 201 of FIG. 2) at the mobile device (e.g., 130 of FIG. 1) during execution of the first program instructions by the mobile device. As shown in FIG. 8D, the first content 810 is not displayed, but the second content 820 is displayed. As shown in FIG. 8D, the second content does not occupy the entire display area. In some embodiments, the width and height display values for the second content 820 are less than 100% of the full width and height values, respectively.

FIG. 8E depicts an exemplary rendering 804 of the markup-language document (e.g., 201 of FIG. 2) at the mobile device (e.g., 130 of FIG. 1) prior to execution of the first program instructions by the mobile device. As shown in FIG. 8E, the first content 810 is displayed, but the second content is not displayed. As shown in FIG. 8E, the first content 810 is an image of a video play button.

FIG. 8F depicts an exemplary rendering 806 of the markup-language document (e.g., 201 of FIG. 2) at the mobile device (e.g., 130 of FIG. 1) during execution of the first program instructions by the mobile device. As shown in FIG. 8F, the first content 810 is not displayed, but the second content 820 is displayed and a third content 830 is also displayed. As depicted in FIG. 8F, the third content 830 is displayed on top of the second content 820. In some embodiments, the third content 830 is displayed in a layer that is above a layer of the second content 820. As shown in FIG. 8F, the second content 820 occupies the entire display area. In some embodiments, the width and height display values for the second content 820 are both 100%. In some embodiments, video controls 807 are displayed.

In some embodiments, during rendering of the markup-language document (e.g., 200 of FIG. 2) by the mobile device (e.g., during the rendering of FIG. 8A, 8E), and responsive to detection of a user-click event (e.g., “onclick”) for the first content (e.g., the video play button 810 of FIG. 8E) by the mobile device, the mobile device executes the first program instructions (e.g., 703 of FIG. 7A-B). During execution of the first program instructions by the mobile device, the mobile device hides the first content and displays the second content (e.g., as shown in FIG. 8B, 8C, 8D, 8F).

In some embodiments, during rendering of the markup-language document (e.g., 200 of FIG. 2) by the mobile device (e.g., during the rendering of FIG. 8C, 8F), and responsive to detection of a user-click event (e.g., “onclick”) for the third content (e.g., 830 of FIG. 8C, the “done” button 830 of FIG. 8F) by the mobile device, the mobile device executes the second program instructions (e.g., 704 of FIG. 7A-B). During execution of the second program instructions by the mobile device, the mobile device hides the second content and displays the first content (e.g., as shown in FIG. 8A, 8E).

17. Video Tour Guide Application

In some embodiments, the application data (e.g., 140 of FIG. 1) is application data for a mobile video tour guide application, and the mobile device (e.g., 130 of FIG. 1) provides to the application store system (e.g., 120 of FIG. 1) a request to download the application data of the mobile video tour guide application. In some embodiments, the mobile device provides the request to download to the application store system via a network device (e.g., 1111 of FIG. 11) of the mobile device. In some embodiments, the mobile device provides the request to download to the application store system via the Internet. In some embodiments, the mobile device provides the request to download to the application store system via a Wide Area Network (WAN). In some embodiments, the mobile device provides the request to download to the application store system via a Local Area Network (LAN). In some embodiments, the application data of the mobile video tour guide application includes data of at least one video clip of the video tour guide application. In some embodiments, the application data of the mobile video tour guide application includes data of a plurality of video clips.

In some embodiments, the application data of the mobile video tour guide application includes program instructions for controlling the mobile device to download at least one video clip from an external system that stores the at least one video clip of the mobile video tour guide application. In some embodiments, the application data of the mobile video tour guide application includes program instructions for receiving at least one video clip from an external system that stores the at least one video clip of the mobile video tour guide application. In some embodiments, the mobile device is constructed to receive the at least one video clip from an external system that stores the at least one video clip via a push notification system (e.g., an Apple push notification system, a Google push notification system and the like). In some embodiments, the mobile device is constructed to receive the at least one video clip from an external system that stores the at least one video clip via a pub-sub system (e.g., an Apple pub-sub system, a Google pub-sub system and the like).

In some embodiments, the mobile device receives a response to the request from the application store system, and the response includes the application data, and the application data includes a markup-language document (e.g., 201 of FIG. 2, 301 of FIGS. 3A-3N, 701 of FIG. 7A) and first program instructions (e.g., 202 of FIG. 2, 303 of FIGS. 3A-3N, 703 of FIGS. 7A and 7B).

In some embodiments, the markup-language document (e.g., 201 of FIG. 2, 301 of FIGS. 3A-3N, 701 of FIG. 7A) includes a visible first element (e.g., an element corresponding the rendering 804 of FIG. 8E) and a hidden second element (e.g., an element corresponding to the rendering 806 of FIG. 8F).

In some embodiments, the first element specifies: first content, a mapping of a first callback to a first event standard attribute. In some embodiments, the first content is content of a user interface element (e.g., 810 of FIG. 8E) that corresponds to a video play control. In some embodiments, the first callback is a callback for the video play control. In some embodiments, the first event standard attribute corresponds to a user selection event for the user interface element of the first content (e.g., 810 of FIG. 8E).

In some embodiments, the second element specifies: second content, and a first standard attribute having a first attribute value. In some embodiments, the second content is a video clip of the video tour guide application, and the video clip is stored on a storage device (e.g. 1105 of FIG. 11) of the mobile device. In some embodiments, the second content is a reference to a video clip of the video tour guide application, and the video clip is stored on a storage device of the mobile device. In some embodiments, the video clip is a video clip that provides information about a point of interest included in the video tour guide. In some embodiments, the second element includes content of a user interface element (e.g., 830 of FIG. 8F) that corresponds to a control for returning display of the first element and hiding of the second element. In some embodiments, the second element includes a second callback for the control for returning display of the first element and hiding of the second element. In some embodiments, the second element includes a mapping of the second callback to a second event standard attribute that corresponds to a user selection event for the user interface element of the second content (e.g., 830 of FIG. 8F). In some embodiments, the second element includes a video control 807.

In some embodiments, the program instructions for the first callback include instructions for controlling the presentation engine of a mobile device to hide the first element (e.g., of the rendering 804 of FIG. 8E), display the second element (e.g., of the rendering 806 of FIG. 8F) and play the video clip of the second element during rendering of the markup-language document by the presentation engine by using a document object model (DOM) for the markup language. In some embodiments, the first element and the second element are standard elements of the DOM, and the first standard attribute is a standard attribute of the DOM.

In some embodiments, the program instructions for the second callback include instructions for controlling the presentation engine of a mobile device to display the first element (e.g., of the rendering 804 of FIG. 8E), stop playback of the video clip of the second element, and hide the second element (e.g., of the rendering 806 of FIG. 8F) during rendering of the markup-language document by the presentation engine by using a document object model (DOM) for the markup language. In some embodiments, the first element and the second element are standard elements of the DOM, and the first standard attribute is a standard attribute of the DOM.

In some embodiments, the presentation engine of the mobile device renders the markup-language document by using the DOM.

In some embodiments, the mobile device executes the program instructions for the first callback responsive to detection of user-selection of the user interface element of the first content (e.g., 810 of FIG. 8E), and the mobile device executing the program instructions for the first callback includes: the presentation engine of the mobile device hiding the first element and displaying the second element during rendering of the markup-language document by the presentation engine.

In some embodiments, the mobile device executes the program instructions for the second callback responsive to detection of user-selection of the user interface element of the second content (e.g., 830 of FIG. 8F), and the mobile device executing the program instructions for the second callback includes: the presentation engine of the mobile device displaying the first element and hiding the second element during rendering of the markup-language document by the presentation engine.

In some embodiments, the first standard attribute is a display attribute having a first attribute value that specifies a display size for the video clip. In some embodiments, the first standard attribute is a display attribute having a first attribute value that specifies a display dimension for the video clip. In some embodiments, the first standard attribute is a display attribute having a first attribute value for full-screen display of the video clip.

In some embodiments, the mobile device executes the mobile video tour guide application in an off-line mode during which the network device (e.g., 1111 of FIG. 11) of the mobile device is not connected to an external network. In some embodiments, the mobile device executes the mobile video tour guide application in an off-line mode during which the network device of the mobile device is not connected to a network. In some embodiments, the mobile device executes the mobile video tour guide application in an off-line mode during which the network device of the mobile device is not connected to the Internet.

In some embodiments, the mobile device is an iPad. In some embodiments, the mobile device is an iPhone. In some embodiments, the presentation engine includes Webkit. In some embodiments, the presentation engine uses Webkit to display the first element, hide the first element, display the second element, and hide the second element.

In some embodiments, the first standard attribute is a display attribute having a first attribute value for full-screen display of the video clip, the mobile device is an iPad, and the presentation engine uses Webkit to display the first element, hide the first element, display the second element, and hide the second element.

### System Architecture: Application Developer System

FIG. 9 is a diagram depicting system architecture of an application developer system 110, according to embodiments.

In some embodiments, application developer system 110 is implemented as a single hardware server device 110. In some embodiments, the application developer system 110 is implemented as a plurality of hardware devices similar to the hardware server device 110 of FIG. 9.

In some embodiments, the application developer system 110 includes a bus 901 that interfaces with the processors 901A-901N, the main memory (e.g., a random access memory (RAM)) 922, a read only memory (ROM) 904, a processor-readable storage medium 905, and a network device 911. In some embodiments, the application developer system 110 includes at least one of a display device 924 and a user input device 923. In some embodiments, the device 110 includes one processor (e.g., 901A).

The processors 901A-901N may take many forms, such as one or more of a microcontroller, a CPU (Central Processing Unit), a GPU (Graphics Processing Unit), and the like. In some embodiments, application developer system 110 includes at least one of a central processing unit (processor), a GPU, and a multi-processor unit (MPU).

The processors 901A-901N and the main memory 922 form a processing unit 999. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

The network adapter device 911 provides one or more wired or wireless interfaces for exchanging data and commands between the system 110 and other devices, such as an application store system. Such wired and wireless interfaces include, for example, a universal serial bus (USB) interface, Bluetooth interface, Wi-Fi interface, Ethernet interface, InfiniBand interface, Fibre Channel interface, near field communication (NFC) interface, and the like.

Machine-executable instructions in software programs (such as an operating system, application programs, and device drivers) are loaded into the memory 922 (of the processing unit 999) from the processor-readable storage medium 905, the ROM 904 or any other storage location. During execution of these software programs, the respective machine-executable instructions are accessed by at least one of processors 901A-901N (of the processing unit 999) via the bus 901, and then executed by at least one of processors 901A-901N. Data used by the software programs are also stored in the memory 922, and such data is accessed by at least one of processors 901A-901N during execution of the machine-executable instructions of the software programs. The processor-readable storage medium 905 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like.

The processor-readable storage medium 905 includes machine-executable instructions (and related data) for an operating system 912, software programs 913, and device drivers 914. In some embodiments, the storage medium 905 includes the application data 140. In some embodiments, the storage medium includes machine-executable program instructions for controlling the application developer system to perform the processes S410, S420, S430 and S440 of FIG. 4. In some embodiments, the storage medium includes machine-executable program instructions for controlling the application developer system to perform the process S410. In some embodiments, the storage medium includes machine-executable program instructions for controlling the application developer system to perform the process S420. In some embodiments, the storage medium includes machine-executable program instructions for controlling the application developer system to perform the process S430. In some embodiments, the storage medium includes machine-executable program instructions for controlling the application developer system to perform the process S440.

In some embodiments, the storage medium 905 stores application data (e.g., 140) that includes a markup-language document similar to 701 of FIG. 7A, first program instructions similar to 703 of FIG. 7B, and second program instructions similar to 704 of FIG. 7B.

In some embodiments, the storage medium 905 stores application data (e.g., 140) that includes the markup-language document 701 of FIG. 7A, the first program instructions 703 of FIG. 7B, and the second program instructions 704 of FIG. 7B.

In some embodiments, the storage medium 905 stores application data similar to at least one of the application data 300A-300N of FIGS. 3A-3N, and the application data 700 of FIG. 7A.

In some embodiments, the storage medium 905 stores the markup-language document generation module 915 described herein. In some embodiments, the storage medium 905 stores the program instructions generation module 916 described herein. In some embodiments, the storage medium 905 stores the application data generation module 917 described herein.

In some embodiments, the markup-language document generation module 915 includes machine executable instructions for controlling the application developer system to generate the markup-language document. In some embodiments, the markup-language document generation module 915 includes machine executable instructions for controlling the application developer system to generate the markup-language document based on information received via the user-input device 923. In some embodiments, the markup-language document generation module 915 is a compiler. In some embodiments, the markup-language document generation module 915 is an IDE (Integrated Development Environment). In some embodiments, the markup-language document generation module 915 is the Apache Cordova cross-platform development framework. In some embodiments, the markup-language document generation module 915 includes at least one library.

In some embodiments, the program instructions generation module 916 includes machine executable instructions for controlling the application developer system to generate the first program instructions (e.g., 703 of FIG. 7A) and the second program instructions (e.g., 704 of FIG. 7B). In some embodiments, the program instructions generation module 916 includes machine executable instructions for controlling the application developer system to generate the program instructions based on information received via the user-input device 923. In some embodiments, the program instructions generation module 916 is a compiler. In some embodiments, the program instructions generation module 916 is an IDE (Integrated Development Environment). In some embodiments, the program instructions generation module 916 is the Apache Cordova cross-platform development framework. In some embodiments, the program instructions generation module 916 includes at least one code library.

In some embodiments, the application data generation module 917 includes machine executable instructions for controlling the application developer system to generate the application data 140. In some embodiments, the application data generation module 917 includes machine executable instructions for controlling the application developer system to generate the application data 140 based on information received via the user-input device 923. In some embodiments, the application data generation module 917 is a compiler. In some embodiments, the application data generation module 917 is an IDE (Integrated Development Environment). In some embodiments, the application data generation module 917 is the Apache Cordova cross-platform development framework. In some embodiments, the application data generation module 917 includes at least one code library.

### System Architecture: Application Store System

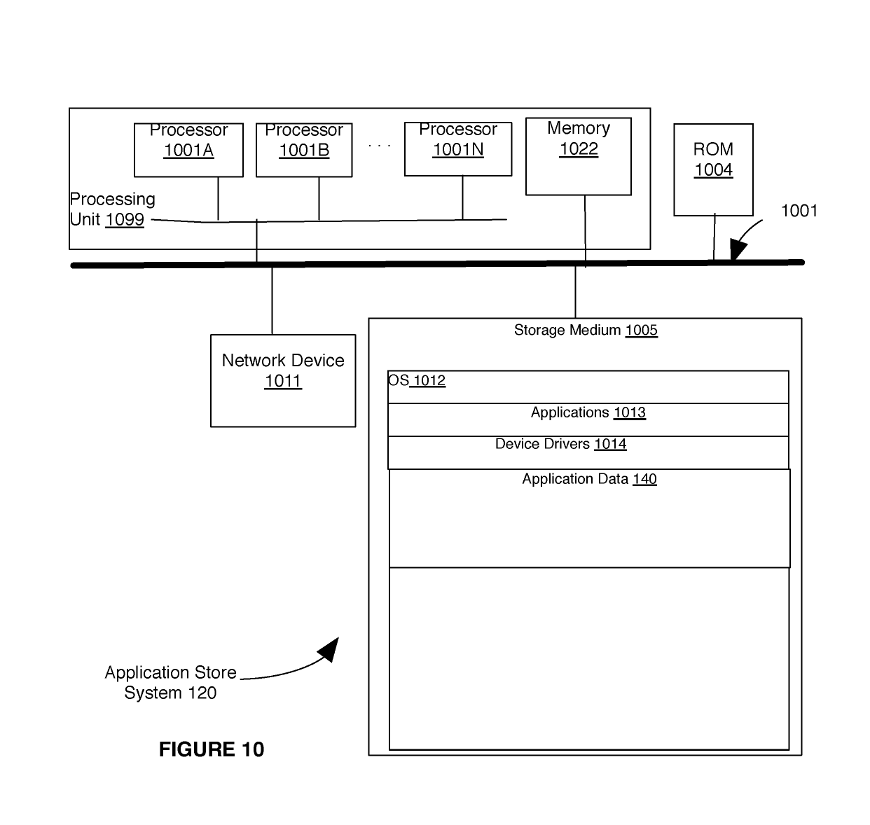

FIG. 10 is a diagram depicting system architecture of an application store system 120, according to embodiments.

In some embodiments, application store system 120 is implemented as a single hardware server device 120. In some embodiments, the application store system 120 is implemented as a plurality of hardware devices similar to the hardware server device 120 of FIG. 10.

In some embodiments, the application store system 120 includes a bus 1001 that interfaces with the processors 1001A-1001N, the main memory (e.g., a random access memory (RAM)) 1022, a read only memory (ROM) 1004, a processor-readable storage medium 1005, and a network device 1011. In some embodiments, the application store system 120 includes at least one of a display device and a user input device. In some embodiments, the device 120 includes one processor (e.g., 1001A).

The processors 1001A-1001N may take many forms, such as one or more of a microcontroller, a CPU (Central Processing Unit), a GPU (Graphics Processing Unit), and the like. In some embodiments, application store system 120 includes at least one of a central processing unit (processor), a GPU, and a multi-processor unit (MPU).

The processors 1001A-1001N and the main memory 1022 form a processing unit 1099. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

The network adapter device 1011 provides one or more wired or wireless interfaces for exchanging data and commands between the system 120 and other devices, such as an application developer system and a mobile device. Such wired and wireless interfaces include, for example, a universal serial bus (USB) interface, Bluetooth interface, Wi-Fi interface, Ethernet interface, InfiniBand interface, Fibre Channel interface, near field communication (NFC) interface, and the like.

Machine-executable instructions in software programs (such as an operating system, application programs, and device drivers) are loaded into the memory 1022 (of the processing unit 1099) from the processor-readable storage medium 1005, the ROM 1004 or any other storage location. During execution of these software programs, the respective machine-executable instructions are accessed by at least one of processors 1001A-1001N (of the processing unit 1099) via the bus 1001, and then executed by at least one of processors 1001A-1001N. Data used by the software programs are also stored in the memory 1022, and such data is accessed by at least one of processors 1001A-1001N during execution of the machine-executable instructions of the software programs. The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like.

The processor-readable storage medium 1005 includes machine-executable instructions (and related data) for an operating system 1012, software programs 1013, and device drivers 1014. In some embodiments, the storage medium 1005 includes the application data 140. In some embodiments, the storage medium includes machine-executable program instructions for controlling the application store system to perform the processes S510, S520, and S530 of FIG. 5. In some embodiments, the storage medium includes machine-executable program instructions for controlling the application store system to perform the process S510. In some embodiments, the storage medium includes machine-executable program instructions for controlling the application store system to perform the process S520. In some embodiments, the storage medium includes machine-executable program instructions for controlling the application store system to perform the process S530.

In some embodiments, the storage medium 1005 stores application data (e.g., 140) that includes a markup-language document similar to 701 of FIG. 7A, first program instructions similar to 703 of FIG. 7B, and second program instructions similar to 704 of FIG. 7B.

In some embodiments, the storage medium 1005 stores application data (e.g., 140) that includes the markup-language document 701 of FIG. 7A, the first program instructions 703 of FIG. 7B, and the second program instructions 704 of FIG. 7B.

In some embodiments, the storage medium 1005 stores application data similar to at least one of the application data 300A-300N of FIGS. 3A-3N, and the application data 700 of FIG. 7A.

### System Architecture: Mobile Device

FIG. 11 is a diagram depicting system architecture of mobile device 130, according to embodiments.

In some embodiments, the mobile device 130 includes a bus 1101 that interfaces with the processors 1101A-1101N, the main memory (e.g., a random access memory (RAM)) 1122, a read only memory (ROM) 1104, a processor-readable storage medium 1105, and a network device 1111. In some embodiments, the mobile device 130 includes at least one of a display device 1124 and a user input device 1123. In some embodiments, the mobile device 130 includes one processor (e.g., 1101A).

The processors 1101A-1101N may take many forms, such as one or more of a microcontroller, a CPU (Central Processing Unit), a GPU (Graphics Processing Unit), and the like. In some embodiments, mobile device 130 includes at least one of a central processing unit (processor), a GPU, and a multi-processor unit (MPU).

The processors 1101A-1101N and the main memory 1122 form a processing unit 1199. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip).

The network adapter device 1111 provides one or more wired or wireless interfaces for exchanging data and commands between the mobile device 130 and other devices, such as an application store system. Such wired and wireless interfaces include, for example, a universal serial bus (USB) interface, Bluetooth interface, Wi-Fi interface, Ethernet interface, InfiniBand interface, Fibre Channel interface, near field communication (NFC) interface, and the like.

Machine-executable instructions in software programs (such as an operating system, application programs, and device drivers) are loaded into the memory 1122 (of the processing unit 1199) from the processor-readable storage medium 1105, the ROM 1104 or any other storage location. During execution of these software programs, the respective machine-executable instructions are accessed by at least one of processors 1101A-1101N (of the processing unit 1199) via the bus 1101, and then executed by at least one of processors 1101A-1101N. Data used by the software programs are also stored in the memory 1122, and such data is accessed by at least one of processors 1101A-1101N during execution of the machine-executable instructions of the software programs. The processor-readable storage medium 1105 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like.

The processor-readable storage medium 1105 includes machine-executable instructions (and related data) for an operating system 1112, software programs 1113, and device drivers 1114. In some embodiments, the storage medium 1105 includes the application data 140, the presentation engine 1115, and the document object model (DOM) 1116. In some embodiments, the storage medium includes machine-executable program instructions for controlling the mobile device to perform the processes S610, S620, S630 and S640 of FIG. 6. In some embodiments, the storage medium includes machine-executable program instructions for controlling the mobile device to perform the process S610. In some embodiments, the storage medium includes machine-executable program instructions for controlling the mobile device to perform the process S620. In some embodiments, the storage medium includes machine-executable program instructions for controlling the mobile device to perform the process S630. In some embodiments, the storage medium includes machine-executable program instructions for controlling the mobile device to perform the process S640.

In some embodiments, the storage medium 1105 stores application data (e.g., 140) that includes a markup-language document similar to 701 of FIG. 7A, first program instructions similar to 703 of FIG. 7B, and second program instructions similar to 704 of FIG. 7B.

In some embodiments, the storage medium 1105 stores application data (e.g., 140) that includes the markup-language document 701 of FIG. 7A, the first program instructions 703 of FIG. 7B, and the second program instructions 704 of FIG. 7B.

In some embodiments, the storage medium 1105 stores application data similar to at least one of the application data 300A-300N of FIGS. 3A-3N, and the application data 700 of FIG. 7A.

### Machines

The systems and methods of some embodiments and variations thereof can be embodied and/or implemented at least in part as a machine configured to receive a computer-readable medium storing computer-readable instructions. The instructions are preferably executed by computer-executable components. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

### CONCLUSION

As a person skilled in the art will recognize from the previous detailed description and from the figures and claims, modifications and changes can be made to the embodiments disclosed herein without departing from the scope defined in the claims.

What is claimed is:

1. A method comprising:
an application developer system generating a markup-language document that includes a visible first element and a hidden second element,
wherein the first element specifies:
first content, a
a mapping of a first callback to a first event standard attribute, and
wherein the second element specifies:
second content, and
a first standard attribute having a first attribute value;
the application developer system generating first program instructions for the first callback, wherein the first program instructions include instructions for controlling a presentation engine of a mobile device to hide the first element and display the second element during rendering of the markup-language document by the presentation engine by using a document object model (DOM) for the markup language;
the application developer system generating application data that includes the markup-language document and the first program instructions; and
the application developer system providing the application data to an application store system via a network,
wherein the first element and the second element are standard elements of the DOM, and
wherein the first standard attribute is a standard attribute of the DOM.

2. The method of claim 1,
wherein the first program instructions include instructions for controlling the presentation engine to hide the first element by modifying a value of a standard display attribute of the first element by using the DOM, and
wherein the first program instructions include instructions for controlling the presentation engine to display the second element by modifying a value of a standard display attribute of the second element by using the DOM, and
wherein the standard display attribute of the first element is different from the first standard attribute, and
wherein the standard display attribute of the second element is different from the first standard attribute.

3. The method of claim 1, wherein the first standard attribute is a standard display dimension attribute of the DOM, and wherein the second element is displayed in accordance with the first attribute value of second element.

4. The method of claim 3, wherein the first attribute value is one of a height value and a width value.

5. The method of claim 2, wherein the first event standard attribute is an attribute for a user interaction event associated with user interaction for the first element, and wherein the first event standard attribute is a standard attribute of the DOM.

6. The method of claim 5,
wherein the second element specifies a mapping of a second callback to a second event standard attribute for a user interaction event associated with user interaction for the second element,
the method further comprising: the application developer system generating second program instructions for the second callback, wherein the second program instructions include instructions for controlling the presentation engine to hide the second element and display the first element during rendering of the markup-language document by using the DOM, and
wherein the application data includes the markup-language document, the first program instructions, and the second program instructions.

7. The method of claim 6,
wherein the first content is different from the second content,
wherein the second element includes a first sub-element that specifies the second content, and
wherein the second element includes a second sub-element that specifies the mapping of the second callback to the second event standard attribute.

8. The method of claim 7, wherein the first element is an element of a first type and the second element is an element of a different type,

9. The method of claim 8, wherein the application store system provides the application data to the mobile device via the network.

10. The method of claim 9, wherein the mobile device executes the first program instructions for the first callback responsive to detection of an event associated with the first event standard attribute, wherein the mobile device executes the second program instructions for the second callback responsive to detection of an event associated with the second event standard attribute, and wherein a display device displays the second content.

11. The method of claim 10, wherein the first element specifies the first standard attribute having a second attribute value different from the first attribute value of the second element, and wherein the first element is displayed in accordance with the second attribute value of the first standard attribute of the first element.

12. The method of claim 1,
wherein the presentation engine is constructed to process the markup-language document in accordance with the DOM,
wherein the presentation engine is constructed to execute the first program instructions for the first callback, and
wherein the presentation engine is constructed to render the markup-language documents in accordance with style definitions included in the markup-language document.

13. The method of claim 1, wherein the mobile device executes the first program instructions in an offline mode during which the mobile device is disconnected from the network, and wherein the mobile device stores the first content, the second content, the markup-language document, and the first program instructions.

14. The method of claim 1,
wherein the first program instructions include instructions for controlling the presentation engine to:
select a video clip from a plurality of video clips stored on a storage device of the mobile device;
set the selected video clip as a video source of the second element;
load the selected video clip;
play the selected video clip; and
set a standard display attribute of the second element to a visible value by using the DOM.

15. The method of claim 1, wherein the first content is the same as the second content.

16. The method of claim 1, wherein the first content is substitute content for the second content.

17. The method of claim 1, wherein the second element includes a reference to the second content.

18. The method of claim 1, wherein the first element includes a first sub-element that specifies the first content.

19. The method of claim 1, wherein the second element includes a first sub-element that specifies the second content.

20. A method comprising:
an application store system receiving from an application developer system application data that includes a markup-language document and first program instructions;
the application store system storing the application data; and
responsive to a request received by the application store system from a mobile device, the application store system providing the stored application data to the mobile device,
wherein the markup-language document includes a visible first element and a hidden second element,
wherein the first element specifies:
first content, a
a mapping of a first callback to a first event standard attribute, and
wherein the second element specifies:
second content, and
a first standard attribute having a first attribute value,
wherein the first program instructions include program instructions for the first callback, wherein the program instructions for the first callback include instructions for controlling a presentation engine of a mobile device to hide the first element and display the second element during rendering of the markup-language document by the presentation engine by using a document object model (DOM) for the markup language,
wherein the first element and the second element are standard elements of the DOM, and
wherein the first standard attribute is a standard attribute of the DOM.
